(19) United States
(12) Patent Application Publication
(10) Pub. No.: US 2026/0268116 A1
(43) Pub. Date: Sep. 10, 2026

(54) Computer Architecture for Interdependent System Simulation

(71) Applicant: N1 Research LLC, Kingstown (VC)

(72) Inventor: Jean-Yves Sireau, Kowloon (HK)

(73) Assignee: N1 Research LLC, Kingstown (VC)

(21) Appl. No.: 19/416,650

(22) Filed: Dec. 11, 2025

Related U.S. Application Data
(60) Provisional application No. 63/766,631, filed on Mar. 4, 2025.

(51) Int. Cl. G06N 3/042; G06N 3/0475; G06N 3/092

(52) U.S. Cl. CPC G06N 3/042; G06N 3/0475; G06N 3/092

(57) ABSTRACT

A computer accesses heterogeneous data from multiple sources and extracts structured entities for predictive analysis. The computer transforms the entities into subsystem-specific records represented as temporally weighted dependency graphs. The computer receives an intervention specification describing a proposed change and associated parameters. The computer generates parameter-dependent predictions by executing a distributed reasoning pipeline that simulates subsystem interactions under a weight-normalized topological traversal. The computer determines predicted subsystem modifications by updating state vectors and storing time-indexed deltas in corresponding tensors. The computer propagates these modifications across graph edges using edge-specific propagation functions to infer secondary effects. The computer aggregates all predicted effects into an intervention analysis structure containing delta tensors, confidence metrics, and causal-provenance identifiers. The computer transmits an output signal displaying predicted responses and enabling visualization, scenario exploration, and outcome comparison through a graphical user interface.

### PRIORITY CLAIM

This application claims priority to U.S. Provisional Patent Application No. 63/766,631, filed on March 4, 2025, and titled “Multi-Agent Artificial Intelligence Engine for Processing Cross-Domain Data,” the entirety of which is incorporated herein by reference.

### TECHNICAL FIELD

Embodiments pertain to computer architecture. Some embodiments relate to artificial intelligence. Some embodiments relate to interdependent system simulation using artificial intelligence techniques.

### BACKGROUND

Interdependent and data-intensive systems such as medical data systems, transportation networks, energy grids, or biological environments produce vast quantities of heterogeneous information originating from diverse and often incompatible sources. These data streams typically differ in format, temporal granularity, and semantic structure, making it difficult to construct a coherent representation of the system as a whole or to analyze how changes in one subsystem might influence others. Conventional computational tools tend to process such data sequentially or in isolated silos, leading to inefficiencies, latency, and limited scalability when performing high-resolution, interdependent simulations. One technical problem, therefore, lies in enabling distributed computing resources to handle the ingestion, normalization, and simulation of interconnected subsystems in a way that preserves cross-system dependencies and supports dynamic, real-time prediction of outcomes for complex systems – whether a city infrastructure, an industrial process, or, by analogy, a patient’s physiology – without overwhelming computational capacity or losing synchronization across processing nodes.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition artificial intelligence program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 is a block diagram of an artificial intelligence system for simulation, in accordance with some embodiments.

FIG. 7 is a block diagram of a distributed computing environment, in accordance with some embodiments.

FIG. 8 is a flow chart of a technique for simulation, in accordance with some embodiments.

FIG. 9 is a flow chart of a technique for processing predicted modification and secondary effects in a simulation, in accordance with some embodiments.

FIG. 10 is a flow chart of a technique for allocating computing resources for simulation within a distributed computing environment, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some implementations provide a computer-implemented framework for efficiently modeling and simulating the interdependencies of interdependent systems by leveraging distributed computing and artificial intelligence. The approach begins with the ingestion of heterogeneous data from multiple, disparate sources – such as text documents, sensor outputs, image files, or structured databases – and the extraction of structured entities using optical character recognition, natural language processing, statistical analysis, or feature- extraction algorithms. A data normalization engine executed by one or more computing devices then transforms the extracted entities into an electronic record organized into subsystem-specific data sections, each of which includes dependency mappings and temporal progressions that define how different parts of the system interact over time. This transformation converts fragmented, inconsistent data into a unified, machine-readable representation suitable for computational analysis.

Once the unified record is constructed, the system employs an artificial intelligence model trained to simulate interdependencies within complex systems. The model sequentially traverses the subsystem-specific data sections to predict how proposed changes or interventions will modify the system’s behavior. For each subsystem, the model determines direct effects of the change, propagates those effects along predefined dependency mappings to identify secondary or cascading influences, and aggregates the resulting modifications into a consolidated analysis data structure. These operations can be executed in parallel across distributed computing nodes, which communicate to exchange intermediate results and synchronize updates, thereby improving throughput and scalability for large, data-rich systems.

Some implementations involve generating and displaying a structured output, such as a graphical interface or interactive report, that presents predicted multi-subsystem responses to the proposed change. This visualization allows users to explore alternative intervention scenarios and compare outcomes across parameters. In a medical implementation, the same framework operates on patient-specific laboratory data, imaging records, and genomic profiles to build a computational physiology model, simulate the effects of candidate treatments or dosages, and present clinicians with projected physiological responses and safety indicators. In this way, some implementations provide a general technical solution for transforming fragmented multi-source data into an integrated, predictive simulation environment applicable across domains, including but not limited to healthcare.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

As used herein, the term “memory” or “memory subsystem” includes one or more memories, where each memory may be a computer-readable medium. A computer-readable medium may be a transitory computer-readable medium or a non-transitory computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “and/or” encompasses its plain and ordinary meaning and may refer to either an intersection or a union of sets of data. In a first example, the phrase “A and/or B” encompasses the intersection of A and B. In a second example, the phrase “A and/or B” encompasses the union of A and B.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

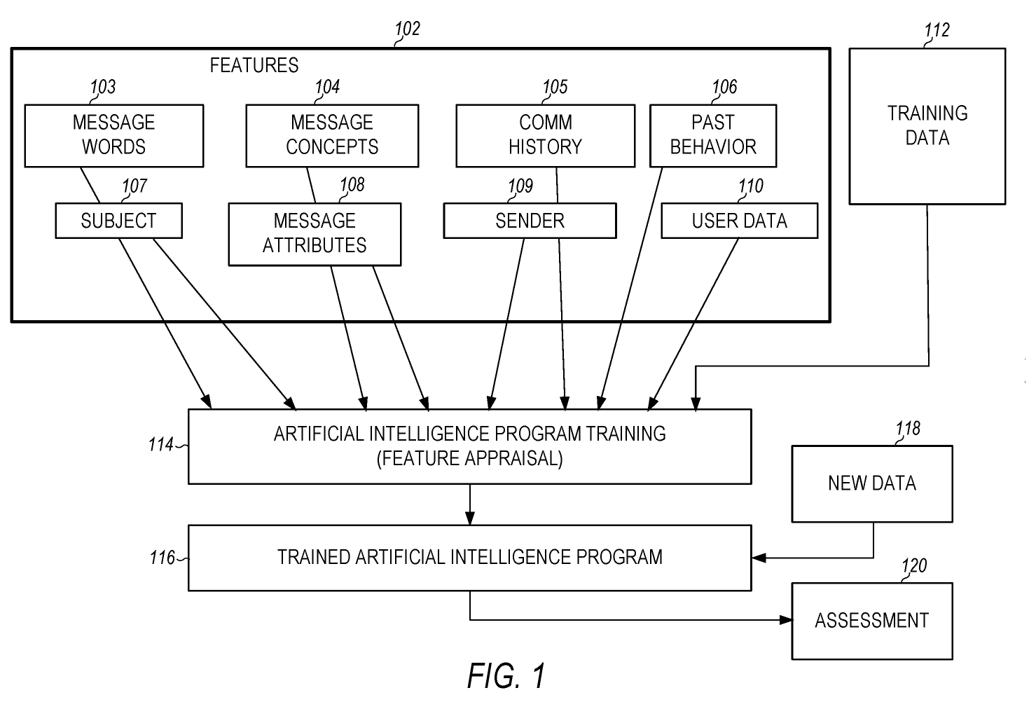

FIG. 1 illustrates the training and use of a machine-learning program, according to some example embodiments. In some example embodiments, machine-learning programs (MLPs), also referred to as machine-learning algorithms or tools, are utilized to perform operations associated with artificial intelligence (AI) tasks, such as image recognition or machine translation.

Artificial intelligence is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in artificial intelligence, a computer could be provided with examples of images of elephants and be trained to determine which images have and lack depictions of elephants, without the programmer encoding explicit instructions as to how to identify an elephant. Artificial intelligence explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in artificial intelligence are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the artificial intelligence tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Artificial intelligence (e.g., machine learning) techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the artificial intelligence technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other artificial intelligence algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n th epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs – having reached a performance plateau – the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

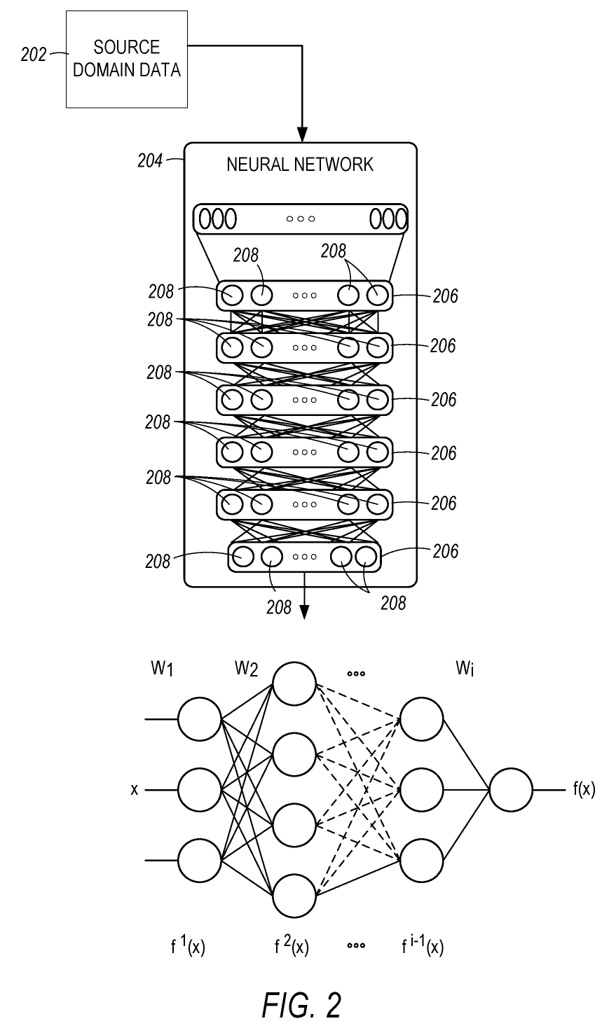

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W 1 , W 2 ,…,W i are applied to the input to each layer to arrive at f 1 (x), f 2 (x),…, f i-1 (x), until finally the output f(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly artificial intelligence, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node’s activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

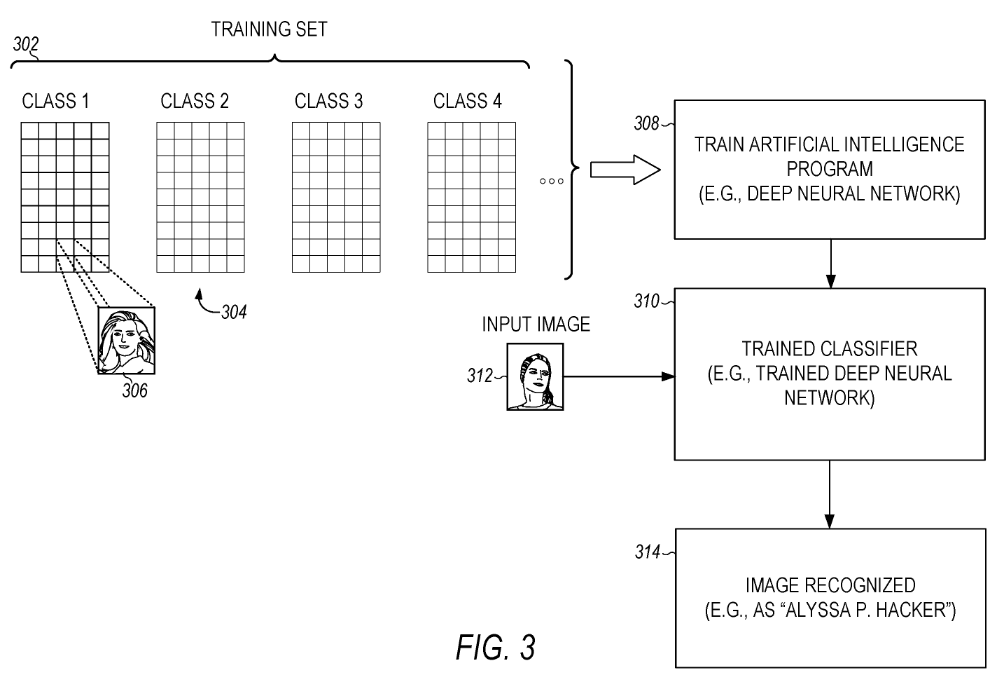

FIG. 3 illustrates the training of an image recognition artificial intelligence program, in accordance with some embodiments. The artificial intelligence program may be implemented at one or more computing machines. Training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In one example, the artificial intelligence program is trained to recognize images of various persons (i.e., to map a photograph of a person to the person’s name), and each class 304 corresponds to each person, with each individual class 304 corresponding to an individual person (e.g., one class corresponds to Alyssa P. Hacker, one class corresponds to Ben Bitdiddle, etc.). At block 308 the artificial intelligence program is trained, for example, using a deep neural network. The trained classifier 310 (e.g., the trained deep neural network), generated by the training of block 308, receives an input image 312, and at block 314 the image is recognized. For example, if the image 312 is a photograph of Alyssa P. Hacker, the classifier recognizes the image as corresponding to Alyssa P. Hacker at block 314. The classifier may include a DNN, as illustrated by the circle with the circular arrows. While examples are described as recognizing images of persons (e.g., such as Alyssa P. Hacker or Ben Bitdiddle) other examples could be used to recognize information in medical images (e.g., x-rays) indicating medical conditions (e.g., osteoporosis, lung inflammation, or intestinal blockage).

FIG. 3 illustrates the training of a classifier, according to some example embodiments. An artificial intelligence algorithm is designed for recognizing faces, and a training set 302 includes data that maps a sample to a class 304 (e.g., a class includes all the images of purses). The classes may also be referred to as labels. Although implementations presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The artificial intelligence program is trained 308 with the training data to generate a classifier 310 operable to recognize images. In some example embodiments, the artificial intelligence program is a DNN.

When an input image 312 is to be recognized, the classifier 310 analyzes the input image 312 to identify the class (e.g., at block 314) corresponding to the input image 312.

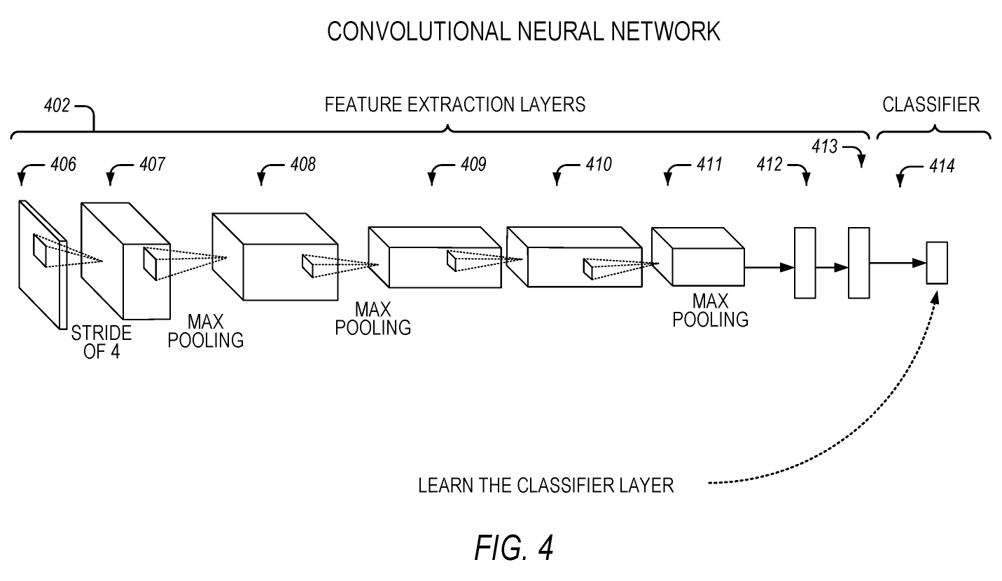

FIG. 4 illustrates a convolutional neural network, according to some example embodiments. Training a classifier of the convolutional neural network may be accomplished with feature extraction layers 402 and classifier layer 414. Each image is analyzed in sequence by a plurality of layers 406-413 in the feature-extraction layers 402.

With the development of deep convolutional neural networks, the focus in face recognition has been to learn a good face embedding-based classifier, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person’s identity. In the ideal case, there is a good face feature extractor (inter-class distance is always larger than the intra-class distance), and the KNN method is adequate to estimate the person’s identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by the classifier layer 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

It should be noted that FIG. 4 illustrates one example of a neural network. Other neural networks may also be used in conjunction with the disclosed technology. Alternatively, some artificial intelligence techniques may leverage other technologies in addition to or in place of neural networks.

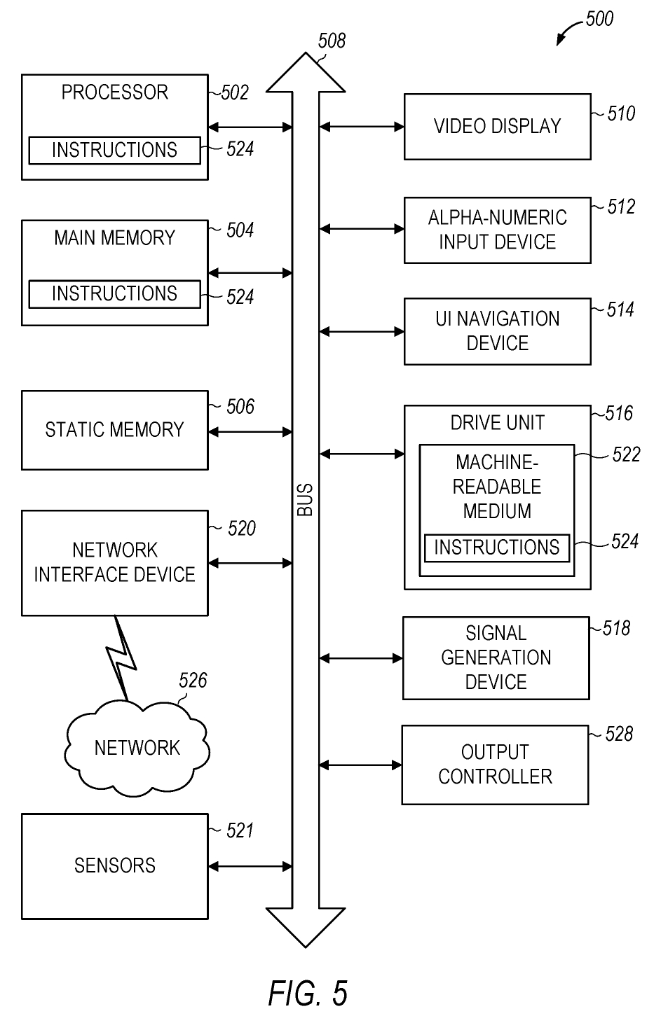

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more CPUs, one or more GPUs, and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a display unit 510 (e.g., a video or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., the drive unit 516), a signal generation device 518 (e.g., a speaker), a network interface device 520, and one or more sensors 521, such as a global positioning system (GPS) sensor, compass, accelerometer, or other sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the drive unit 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

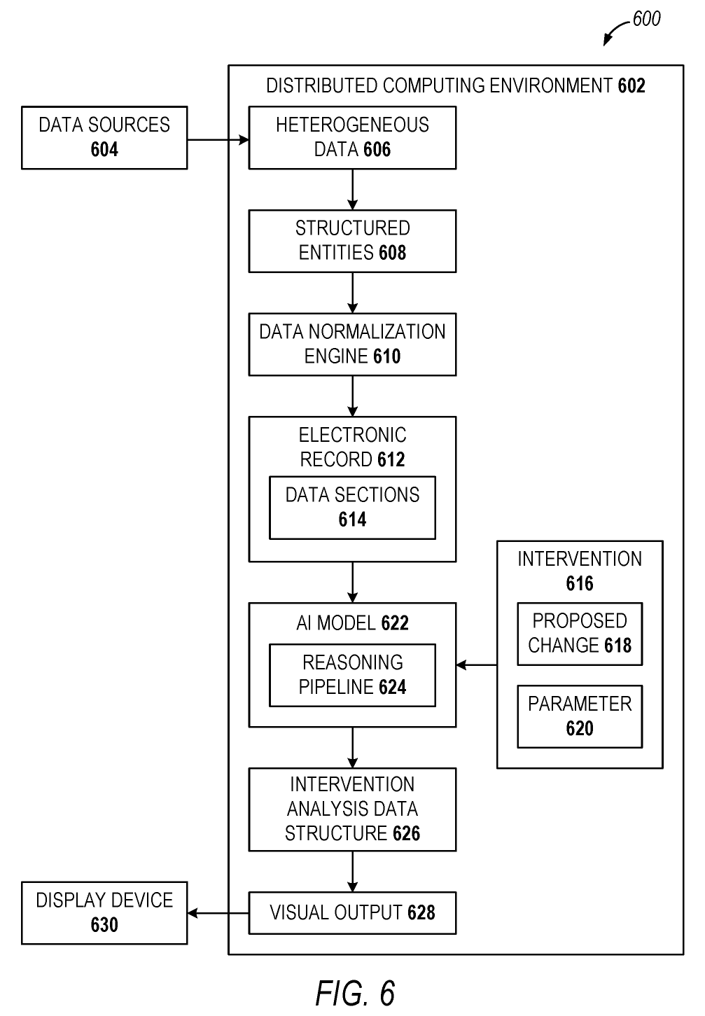

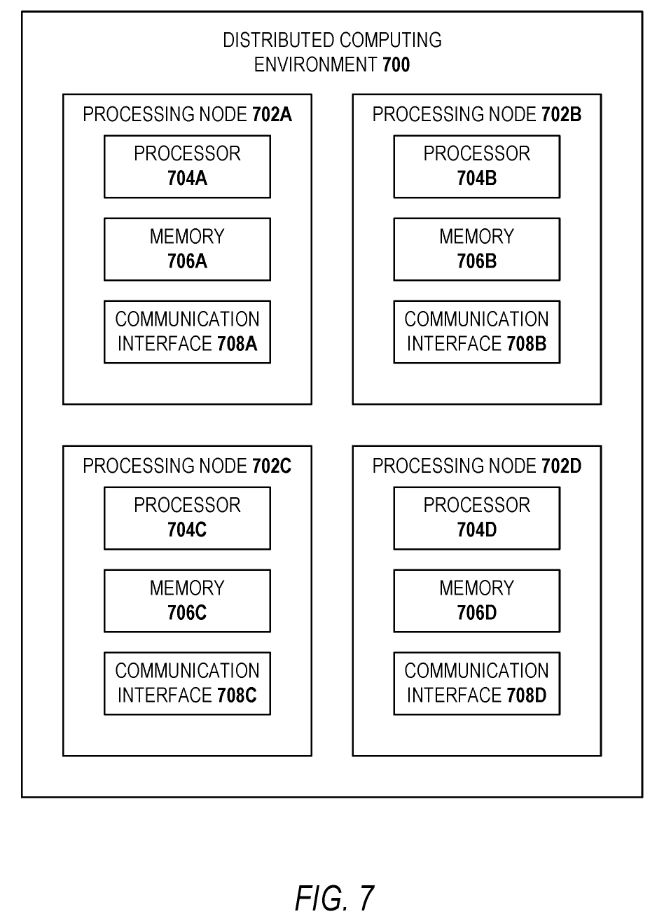

FIG. 6 is a block diagram of an AI system 600 for simulation, in accordance with some embodiments. As shown, the AI system 600 includes a distributed computing environment 602. The distributed computing environment may include one or more computing machines, such as the computing machine 500. An example of a structure of the distributed computing environment 602 is described below in conjunction with FIG. 7. The distributed computing environment 602 receives data from data sources 604. The data sources 604 may include at least one of a database, a data repository, a computing machine (e.g., the computing machine 500), or a computer memory (e.g. at least one of the main memory 504, the static memory 506, or the drive unit 516). The data sources 604 may include heterogeneous inputs originating from disparate domains, and the distributed computing environment 602 accordingly stores heterogeneous data 606 of varying formats, temporal resolutions, and semantic structures. From the heterogeneous data 606, the distributed computing environment 602 generates structured entities 608, which may be extracted using techniques such as optical character recognition, natural language processing, radiomics feature extraction, genomic variant parsing, or statistical analysis. The structured entities 608 are then processed by a data normalization engine 610, which converts the structured entities 608 into an electronic record 612. The electronic record 612 includes data sections 614, where each data section corresponds to a subsystem or functional aspect of a modeled system and includes temporally aligned information, dependency mappings, and representations of sequential state transitions.

The distributed computing environment 602 further receives or accesses an intervention 616. The intervention 616 may include a proposed change 618 to be evaluated against the modeled system, along with a parameter 620 specifying characteristics of the proposed change 618. In medical embodiments, the intervention 616 may include a therapeutic agent and the parameter 620 may specify a dosage, schedule, or route of administration. In non-medical embodiments, the intervention 616 may represent a modification to a municipal infrastructure subsystem, an industrial process, or a networked energy grid, and the parameter 620 may define a policy variable, an operational threshold, or a system configuration value. The distributed computing environment 602 applies an AI model 622 to evaluate the intervention 616. The AI model 622 includes, among other things, a reasoning pipeline 624, which orchestrates a multi-stage computational process that sequentially traverses the data sections 614, determines predicted modifications resulting from the proposed change 618, propagates such modifications to related subsystems, identifies secondary or cascading effects, and reconciles temporal and cross-subsystem interdependencies. The AI model 622 may utilize various AI techniques, such as those described in conjunction with FIGS. 1-4. The AI model 622 may include at least one of an artificial neural network, a convolutional neural network, a deep neural network, a large language model, a generative pretrained transformer, or another AI architecture.

The outputs of the AI model including the reasoning pipeline 624 are aggregated into an intervention analysis data structure 626. The intervention analysis data structure 626 may include temporally indexed delta profiles, cross-subsystem dependency evaluations, confidence metrics, and provenance metadata linking predicted outcomes to the underlying data in the electronic record 612. The distributed computing environment 602 uses the intervention analysis data structure 626 to generate a visual output 628. The visual output 628 provides an interface for presenting predicted responses of the modeled system to the proposed change 618 and may include graphs, charts, and interactive elements allowing a user to explore alternative scenarios and compare predicted outcomes across different values of the parameter 620. The visual output 628 is transmitted to a display device 630, through which the user can view results and, in some embodiments, provide feedback or initiate further analysis. The display device may be a client computing device (e.g., corresponding to the computing machine 500) or a display unit (e.g., the display unit 510) of a computer.

The AI system 600 is configured to access the heterogeneous data 606 from the data sources 604, extract structured entities 608, transform the structured entities into an electronic record 612 using the data normalization engine 610, receive an intervention 616 identifying a proposed change 618 and parameter 620, generate predictions using the AI model 622 and reasoning pipeline 624, aggregate results into the intervention analysis data structure 626, and transmit a signal for display via the visual output 628 on the display device 630. The AI system 600 is applicable to medical embodiments, such as constructing patient-specific computational physiology models and simulating drug effects, biomarker trajectories, organ-level responses, or contraindications, as well as to non-medical embodiments, including simulation of interdependent industrial systems, transportation networks, environmental systems, or energy distribution infrastructures. In some embodiments, the AI system 600 enables complex multi-subsystem simulations supported by distributed computing environment 602 operations and AI-driven reasoning across the data sections 614.

In some embodiments, the electronic record 612 produced by the data normalization engine 610 is further used to automatically generate a long-form, machine-interpretable manuscript referred to as a Patient-Specific Computational Physiology File (PCPF). The PCPF may comprise between 100 and 1000 or more pages of structured analytical content, including narrative explanations, subsystem-specific summaries, temporal biomarker trends, causal pathway descriptions, dependency-resolution logic derived from the cross-subsystem mappings, and system-level integration analyses. The generation of the PCPF may involve AI-driven synthesis modules that convert the structured entities 608 and data sections 614 into cohesive explanatory chapters, each corresponding to a physiological subsystem or functional domain. The manuscript may also incorporate tables, charts, confidence metrics, and model-generated text designed to support clinical or operational interpretation of the underlying subsystem data and predicted system behaviors.

In some embodiments, the electronic record 612 further serves as the foundational input for a chapter-by-chapter physiological modeling framework. Each subsystem-specific data section 614 corresponds to a dedicated chapter of a long-form manuscript, with chapters organized to reflect physiologically distinct domains such as hematologic, endocrine, immune, metabolic, hepatic, renal, cardiovascular, neurological, and gastrointestinal systems. Within each chapter, the system integrates structured data, temporal trajectories, causal dependencies, and model-generated explanations to produce a cohesive physiological narrative. Chapters may include quantitative trend tables, biomarker trajectories, dependency-pathway diagrams, and explanatory text describing subsystem function, subsystem interactions, and inferred physiological compensations. By organizing the electronic record 612 into these subsystem- focused chapters, the system provides a structured physiological modeling representation that is human-readable while preserving machine interpretability.

In some embodiments, the chapter-by-chapter physiological modeling framework organizes the PCPF into a specific multi-chapter structure corresponding to distinct physiological domains and analytical functions. For example, in one embodiment, the PCPF may include the following chapters: (1) Patient Timeline and Medical Events, which presents a chronological reconstruction of clinical encounters, diagnoses, treatments, and outcomes; (2) Hematologic System Analysis, which evaluates blood cell populations, coagulation profiles, and hematological biomarkers; (3) Endocrine and Metabolic System Modeling, which assesses hormonal axes, metabolic substrates, and energy homeostasis; (4) Immune and Inflammatory System Assessment, which analyzes immune cell populations, cytokine profiles, and inflammatory markers; (5) Hepatic and Renal Function Evaluation, which models detoxification capacity, synthetic function, and clearance efficiency; (6) Cardiovascular Function and Vascular Health, which evaluates cardiac output, vascular tone, lipid profiles, and coagulation risk; (7) Neurological and Cognitive Biomarker Assessment, which analyzes neural function markers, cognitive performance indicators, and neuromodulatory states; (8) Gastrointestinal and Microbiome Assessment, which models digestive function, gut barrier integrity, and microbiome-derived metabolic pathways; (9) Toxicology and Environmental Exposure Modeling, which evaluates environmental toxicant exposures, occupational chemical contacts, heavy metal accumulations, and their effects on organ function and detoxification pathways; (10) Genetic and Pharmacogenomic Modifiers, which incorporates genetic variants affecting drug metabolism, receptor sensitivity, and disease susceptibility; (11) Organ-Specific Biological Age Algorithms, which compute subsystem-specific or organ-specific biological ages using temporal biomarker trajectories, recovery dynamics, metabolic efficiency indicators, and model-inferred physiological-reserve metrics; (12) Systems Interaction Graphs and Causal Pathways, which model cross-system dependencies and feedback relationships; (13) Risk Amplifier Identification, which identifies factors that increase vulnerability to adverse outcomes; and (14) Data Integrity Review, which documents source provenance, extraction confidence levels, uncertainty rankings, and identified data quality issues. This fourteen-chapter structure provides comprehensive coverage of patient physiology while enabling modular analysis and simulation. It should be noted that, in alternative embodiments, the PCPF may have other chapters.

In some embodiments, the Data Integrity Review chapter or section catalogs conflicting laboratory values, ambiguous clinical information, missing data fields, or discrepancies between data sources, enabling clinicians or system operators to assess the reliability of the underlying data informing subsystem-specific analyses and intervention simulations. The Data Integrity Review section may further include automated assessments of data completeness, temporal coverage, and cross-source consistency, providing a structured foundation for interpreting the confidence and limitations of model-generated predictions.

In some embodiments, the Toxicology and Environmental Exposure Modeling chapter constitutes a dedicated chapter for environmental exposure modeling that analyzes environmental toxicant exposures, occupational chemical contacts, heavy metal accumulations, and their effects on organ function, detoxification pathways, and systemic health. This chapter integrates structured entities derived from toxicology laboratory panels, exposure questionnaires, environmental sensor data, and clinical documentation of suspected or confirmed toxic exposures. The toxicology chapter may further model interactions between toxicological burdens and other physiological subsystems, such as hepatic detoxification capacity, renal clearance efficiency, neurological vulnerability, and immune sensitization.

In some embodiments, the Neurological and Cognitive Biomarker Assessment chapter specifically incorporates cognitive biomarkers, including markers of memory function, executive function, attention, processing speed, and other cognitive domains. Cognitive biomarker assessment may integrate data from neuropsychological testing, cognitive screening instruments, functional imaging studies, and clinical documentation of cognitive symptoms or diagnoses. The system may model relationships between cognitive biomarkers and other physiological subsystems, such as metabolic, cardiovascular, and endocrine systems that influence brain function.

In some embodiments, the PCPF generation process includes producing causal pathway diagrams that visually represent the directed relationships among physiological subsystems, biomarkers, and clinical outcomes. These causal pathway diagrams may be automatically generated from the cross-subsystem dependency mappings and may illustrate primary, secondary, and tertiary causal drivers of observed or predicted subsystem states, including the directionality and magnitude of influence across physiological domains. The causal pathway diagrams may be incorporated into the Systems Interaction Graphs and Causal Pathways chapter or presented as supplementary visualizations accompanying other chapters.

In some embodiments, the PCPF includes a summary of metabolic clearance rates derived from patient-specific laboratory or genomic data. The metabolic clearance rate summary may incorporate hepatic enzyme activity levels, renal filtration rates, pharmacogenomic variants affecting drug-metabolizing enzymes such as CYP450 alleles, and historical clearance data inferred from medication response patterns. This summary enables the Intervention Simulation Engine to adjust pharmacokinetic predictions based on the patient's individualized metabolic capacity.

In some embodiments, the PCPF further includes a risk-amplifier index derived from multi-system interactions. The risk-amplifier index quantifies the cumulative effect of multiple concurrent risk factors, cross-system vulnerabilities, and synergistic adverse conditions that may amplify the patient's susceptibility to adverse outcomes. The risk-amplifier index may be computed using weighted aggregation of subsystem-specific risk indicators, interaction coefficients derived from the dependency mappings, and empirical risk multipliers derived from clinical evidence. The risk-amplifier index may be presented as a numerical score, a categorical risk tier, or a graphical representation within the Risk Amplifier Identification chapter.

In some embodiments, the PCPF further incorporates temporal, narrative, and mechanistic modeling layers that enrich each subsystem-specific chapter with longitudinal context and causal interpretability. The temporal modeling layer analyzes historical biomarker measurements, sequential state transitions, and subsystem-specific time-series patterns to generate projections of future physiological behavior under baseline and perturbed conditions. The narrative modeling layer synthesizes these quantitative temporal insights into human-readable explanations describing subsystem trajectories, inflection points, compensatory responses, and clinically relevant interpretations tied to the underlying structured entities. The mechanistic modeling layer integrates causal relationships derived from the dependency mappings to reconstruct subsystem-specific and cross-system biological mechanisms, for example, illustrating how metabolic perturbations may influence hepatic clearance, cardiovascular tone, or endocrine regulation. Together, these layers provide a cohesive, multi-dimensional representation of patient-specific physiology, enabling each chapter of the PCPF to present not only static subsystem findings but also dynamic, mechanistically grounded narratives of physiological function over time.

In some embodiments, the AI system 600 additionally incorporates biological-age estimation modules, causal-graph reasoning components, and cross-system pathway modeling to enhance subsystem-level and whole-system interpretability. The biological-age modules may compute subsystem-specific or organ-specific biological ages using temporal biomarker trajectories, recovery dynamics, metabolic efficiency indicators, and model-inferred physiological-reserve metrics, with results integrated into the corresponding chapters of the long-form manuscript. The causal-graph components may operate on the cross-subsystem dependency mappings by identifying primary, secondary, and tertiary causal drivers of observed or predicted subsystem states, including the directionality and magnitude of influence across physiological domains. The cross-system pathway modeling engine may further translate the directed edges of the dependency structure into multi-step physiological interaction pathways, allowing the system to reconstruct how local perturbations propagate through endocrine, metabolic, cardiovascular, immunological, or neurological pathways. Together, these components provide deeper mechanistic context for both baseline physiology and simulated intervention responses, enabling the system to present structured, explainable modeling outputs within each affected subsystem chapter.

FIG. 7 is a block diagram of a distributed computing environment 700, in accordance with some embodiments. The distributed computing environment 700 may correspond to the distributed computing environment 602 described in conjunction with FIG. 6. As shown, the distributed computing environment includes processing nodes 702A-D. While four processing nodes 702A-D are illustrated, the disclosed technology may be implemented with other numbers of processing nodes.

Each of the processing nodes 702A-D may correspond to the computing machine 500 or a subset of the components of the computing machine 500. As shown, the processing node 702A includes a processor 704A, a memory 706A, and a communication interface 708A. The processor 704A may correspond to the processor 502. The memory 706A may correspond to at least one of the main memory 504, the static memory 506, or the drive unit 516. The communication interface 708A may correspond to the network interface device 520. The communication interface 708A allows the processing node 702A to communicate with the other processing nodes 702B-D of the distributed computing environment 700.

The processing node 702B similarly includes a processor 704B, a memory 706B, and a communication interface 708B. The processing node 702C similarly includes a processor 704C, a memory 706C, and a communication interface 708C. The processing node 702D similarly includes a processor 704D, a memory 706D, and a communication interface 708D.

The distributed computing environment 700 illustrated in FIG. 7 provides the structural foundation upon which the distributed computing environment 602 of FIG. 6 operates. As described with respect to FIG. 6, the AI system 600 performs data ingestion, entity extraction, normalization, subsystem-specific modeling, and multi-stage reasoning across potentially large volumes of heterogeneous data 606 and across data sections 614 (which may be subsystem-specific). These operations may be computationally intensive, especially in embodiments involving complex medical datasets, high-resolution sensor streams, imaging archives, genomics files, or industrial process logs. The distributed computing environment 700 enables these workloads to be decomposed and executed in parallel across the processing nodes 702A-D. Each processing node, having its own processor 704A-D and memory 706A-D, may independently perform a portion of the operations involved in generating structured entities 608, constructing the electronic record 612, or evaluating subsystem-level effects during execution of the reasoning pipeline 624.

In some embodiments, the AI model 622 and the reasoning pipeline 624 take explicit advantage of the multiple processors 704A-D and memories 706A-D shown in FIG. 7 by partitioning the data sections 614 across the processing nodes 702A-D. For example, each processing node may be assigned one or more subsystem-specific data sections corresponding to a physiological system in a medical embodiment (e.g., cardiovascular, endocrine, hepatic, renal, or neurological) or to a functional subsystem in a non-medical embodiment (e.g., traffic flow, power distribution, logistics operations, or environmental conditions). During simulation, each processing node may execute a localized portion of the reasoning pipeline 624, including determining predicted modifications resulting from the proposed change 618 and propagating effects to interconnected subsystems. Because each processing node 702A-D includes its own memory 706A-D, the data sections 614 may be stored locally, reducing latency associated with repeated access to large data structures.

The communication interfaces 708A-D of FIG. 7 provide the inter-node connectivity necessary to support the cross-subsystem propagation of modifications and secondary effects described in FIG. 6. When the reasoning pipeline 624 identifies that a modification within one data section produces effects in another subsystem, the processing node responsible for the first subsystem may transmit intermediate results to the processing node responsible for the second subsystem. The communication interfaces 708A-D may implement protocols corresponding to the network interface device 520 of the computing machine 500 and allow for high-bandwidth, low-latency data exchange between nodes. Through such communication, the distributed computing environment 700 ensures that predictions remain synchronized across all subsystems represented in the electronic record 612, thereby maintaining temporal and causal consistency throughout the simulation.

In some embodiments, the distributed computing environment 700 further enables dynamic scaling of the AI system 600. As the volume or complexity of the heterogeneous data 606 increases, additional processing nodes may be instantiated or allocated to expand the distributed computing environment 602. Conversely, when fewer computational resources are needed, the AI system 600 may release or idle certain processing nodes. This flexibility allows the AI system 600 to efficiently accommodate varying workloads across medical embodiments – such as processing newly acquired laboratory results, imaging files, or streaming biometric data – or across non-medical embodiments, such as integrating real-time industrial sensor data or adjusting for fluctuating urban infrastructure loads. By leveraging these properties of the distributed computing environment 700, the AI system 600 achieves high throughput, reduced latency, and improved scalability.

The parallelism supported by the processing nodes 702A-D also enhances the speed of generating the intervention analysis data structure 626 and corresponding visual output 628. For example, in a medical embodiment, the cardiovascular subsystem analysis may run on processing node 702A, while metabolic and endocrine subsystems run on processing nodes 702B and 702C, and neurological modeling runs on processing node 702D. Each processing node computes subsystem-specific predictions and then exchanges results to refine cross-system dependencies. Once the processing nodes 702A-D complete their respective evaluations, the results are synchronized and aggregated into the intervention analysis data structure 626. Similarly, in a non-medical embodiment, the processing nodes 702A-D may concurrently simulate impacts to energy distribution, transportation flow, water management, and emergency service capacity, allowing the AI system 600 to evaluate multifactorial policy or operational changes efficiently.

By way of example, in a medical embodiment, the AI system 600 may be used to evaluate the potential physiological effects of administering a new therapeutic agent to a patient with multiple comorbid conditions. The process begins when the distributed computing environment 602 accesses heterogeneous data 606 from the data sources 604, which store the patient’s clinical data. Such data may include electronic health record entries, laboratory test results, diagnostic imaging studies, genomic variant reports, and biometric sensor data. Using the extraction mechanisms described in conjunction with FIG. 6, the AI system 600 converts the heterogeneous data 606 into structured entities 608, and the data normalization engine 610 constructs the electronic record 612 organized into the data sections 614, which are subsystem-specific data sections. In this example, the data sections 614 may correspond to physiological systems such as cardiovascular, hepatic, renal, metabolic, endocrine, and immune subsystems. This patient-specific electronic record 612 forms the baseline physiological representation used by the AI system 600.

When a clinician specifies an intervention 616 representing a therapeutic agent to be virtually tested, and provides dosage or scheduling information as the parameter 620, the AI model 622 initiates a simulation workflow to evaluate the proposed change 618. During this process, the reasoning pipeline 624 sequentially analyzes each physiological subsystem represented in the data sections 614 and computes predicted modifications attributable to the therapeutic agent. For instance, a drug predicted to alter hepatic enzyme activity may be modeled as modifying metabolic clearance rates in the hepatic subsystem, which in turn may propagate through the cardiovascular, renal, or endocrine subsystems depending on the dependency mappings embedded in the electronic record 612. These predicted effects are consolidated into the intervention analysis data structure 626, which captures both direct impacts and secondary physiological consequences. The visual output 628 then presents these results to the clinician, enabling a review of dose-dependent changes in biomarkers, organ-level responses, contraindications, and potential cross-system interactions.

In some embodiments, the AI model 622 comprises an intervention simulation engine that performs a structured simulation process comprising distinct operational phases. The process may include the following operations: (1) Dose Initialization, in which the system configures simulation parameters based on the specified candidate doses, routes of administration, and dosing schedules (e.g., as indicated within the proposed change 618 and/or the parameter 620); (2) Section-by-Section Traversal, in which the AI model 622 sequentially analyzes each subsystem-specific data section of the PCPF; (3) Subsystem Mechanistic Matching, in which the AI model identifies, for each subsystem-specific data section, the relevant mechanistic pathways, receptor interactions, enzyme activities, or biological targets through which the candidate intervention is expected to exert effects; (4) Prediction of Biomarker Trajectories, in which the system generates temporal projections of how biomarker values will change in response to the intervention at each candidate dose; (5) Cross-System Propagation Modeling, in which the system propagates predicted modifications along the dependency mappings to determine effects on related subsystems; (6) Detection of Contradictions or Amplifications, in which the system identifies subsystem interactions that produce conflicting effects or amplification cascades resulting from simultaneous modulation of multiple subsystems; and (7) Aggregation of Dose-Dependent Effects, in which the system consolidates all subsystem-level predictions into a unified intervention analysis. This seven-step process provides a systematic framework for comprehensive therapeutic simulation.

In some embodiments, the intervention simulation engine identifies amplification cascades resulting from simultaneous modulation of multiple subsystems. An amplification cascade occurs when the modification of one subsystem triggers secondary effects in related subsystems that, in turn, further amplify the original modification or produce synergistic effects exceeding the sum of individual subsystem responses. The system may detect amplification cascades by analyzing the dependency mappings for positive feedback loops, synergistic pathway interactions, or multiplicative effect relationships. Identified amplification cascades may be flagged in the intervention analysis data structure 626 and presented as warnings or alerts in the visual output 628.

In some embodiments, the subsystem mechanistic matching phase employs neural network-based pattern matching against a library of known mechanistic responses. The library may include established biological mechanisms, pharmacological interaction patterns, and empirically validated subsystem response profiles corresponding to various therapeutic agents and intervention types. The neural network may be trained to identify matches between the specified intervention characteristics and the patient's subsystem-specific data, enabling the system to select appropriate mechanistic models for predicting subsystem responses.

In some embodiments, the intervention simulation engine performs cross-validation with known pharmacokinetic datasets to verify the accuracy of predicted drug absorption, distribution, metabolism, and excretion profiles. The cross-validation process may compare simulated pharmacokinetic curves against reference data from clinical trials, population pharmacokinetic studies, or curated pharmacokinetic databases. Discrepancies between simulated and reference pharmacokinetic profiles may trigger model adjustments, confidence reductions, or alerts indicating potential prediction uncertainty.

In some embodiments, the intervention analysis data structure 626 includes an intervention impact report. The intervention impact report generated by the AI system 600 includes a summary of beneficial, neutral, and adverse effects organized by subsystem. This tripartite categorization enables clinicians or system operators to distinguish between subsystems expected to improve under the proposed intervention, subsystems expected to remain stable with minimal change, and subsystems expected to experience adverse or detrimental effects. The summary may present each category using color-coded indicators, tabular formats, or graphical visualizations that facilitate rapid assessment of the overall intervention profile.

In some embodiments, the intervention impact report includes suggested monitoring strategies specifying laboratory tests, imaging studies, clinical assessments, or wearable sensor measurements recommended for tracking subsystem responses and detecting early indicators of adverse effects. The suggested monitoring strategies may be automatically generated based on the predicted subsystem modifications, identified risk regions, and established clinical guidelines for monitoring patients receiving similar interventions. The monitoring strategies may include recommended monitoring frequencies, threshold values triggering clinical action, and escalation protocols for detected adverse trends.

In some embodiments, the intervention impact report includes recommendations for dose optimization identifying parameter ranges, dosing schedules, or administration routes predicted to maximize therapeutic benefit while minimizing adverse subsystem impacts or cross-system risks. The dose optimization recommendations may be derived from comparative analysis of predicted outcomes across multiple candidate doses, identification of therapeutic windows where beneficial effects predominate, and avoidance of dose ranges associated with predicted toxicity or adverse subsystem responses.

In some embodiments, the intervention impact report includes threshold warnings for predicted adverse biomarker excursions. A threshold warning is generated when the simulation predicts that a biomarker value will exceed or fall below a clinically significant threshold in response to the proposed intervention. Threshold warnings may be presented with associated severity levels, temporal predictions indicating when the excursion is expected to occur, and cross-references to the affected subsystem chapters. The threshold warnings enable clinicians to anticipate and prepare for potential adverse developments requiring intervention or monitoring intensification.

In some embodiments, the intervention impact report includes multi-dose response matrices presenting predicted subsystem responses across multiple candidate doses in a structured tabular or matrix format. The multi-dose response matrices enable side-by-side comparison of predicted effects at different dose levels, facilitating identification of dose-response relationships, optimal therapeutic ranges, and dose-dependent risk transitions. The matrices may be presented alongside safety envelopes that graphically delineate parameter ranges associated with acceptable versus unacceptable predicted risk profiles.

In some embodiments, the AI system 600 generates (e.g., within the visual output 628) a visualization dashboard representing manuscript structure, subsystem interactions, and predicted intervention outcomes. The visualization dashboard provides an integrated graphical interface that enables users to navigate the PCPF chapter structure, explore cross-subsystem dependency relationships, view predicted intervention effects across all physiological domains, and compare outcomes across alternative intervention scenarios. The visualization dashboard may include interactive elements such as expandable subsystem panels, zoomable dependency graphs, adjustable dose sliders, and outcome comparison views. The visualization dashboard may be rendered through the visual output 628 and displayed on the display device 630.

In some embodiments, the AI system 600 generates a compliance checklist to support regulatory or clinical review. The compliance checklist may enumerate documentation requirements, data provenance verification steps, model validation confirmations, and quality assurance checkpoints relevant to clinical decision support, regulatory submission, or institutional review processes. The compliance checklist may be automatically populated based on the data sources accessed, the simulation operations performed, and the outputs generated, enabling streamlined review and audit trail documentation.

The simulation workflow is executed efficiently due to the distributed computing environment 700 shown in FIG. 7. When the patient-specific electronic record 612 contains large or complex subsystem data sections 614 – such as detailed radiomic fingerprints, high-dimensional genomic features, or longitudinal laboratory trajectories – these data sections may be partitioned across the processing nodes 702A-D. For example, the processing node 702A may evaluate cardiovascular effects using its processor 704A and memory 706A, while the processing node 702B concurrently evaluates hepatic effects and the processing node 702C evaluates renal clearance effects. Through the communication interfaces 708A-D, intermediate results are exchanged so that downstream subsystems receive updated predictions from upstream systems. The distributed execution ensures that the reasoning pipeline 624 can perform subsystem traversal, interdependency reconciliation, and secondary-effect propagation in a timely manner, even when modeling complex pharmacodynamic or pharmacokinetic interactions.

Once each processing node 702A-D completes its respective computations, the distributed computing environment 602 aggregates the results into the intervention analysis data structure 626. The consolidated data structure reflects the combined outputs of all physiological subsystems, accommodating both direct drug effects and cascading system-wide responses. The distributed architecture ensures that even data-intensive medical simulations – such as evaluating treatments involving gene-expression modifiers, immunomodulators, or multi-drug regimens – can be performed efficiently without overloading any single computing resource. The visual output 628 is then generated and delivered to the display device 630, allowing clinicians to interact with predicted outcomes before applying a therapeutic decision in real-world practice.

Some embodiments described herein enable a single clinician to rapidly evaluate integrated simulation results that span multiple medical disciplines without needing to consult separate specialists for each physiological domain. Because the AI system 600 consolidates heterogeneous patient data 606 into subsystem-specific data sections 614 and evaluates intervention effects using the AI model 622 operating across the distributed computing environment 602 and the processing nodes 702A-D of FIG. 7, the AI system 600 can automatically generate a unified representation of predicted cardiovascular, hepatic, renal, endocrine, metabolic, neurological, and immunologic responses to a proposed treatment. This cross-disciplinary synthesis allows the clinician to review consistent, longitudinal, and causally linked predictions across all major organ systems within a single interface via the visual output 628. Moreover, the distributed computing environment 700 provides parallelized processing that enables complex, data-intensive simulations to be performed with high speed and low latency, allowing clinicians to obtain comprehensive, multi-system simulation results in near real time.

In some embodiments, the distributed computing environment 700 also accelerates the generation of the long-form PCPF manuscript by distributing chapter-level synthesis tasks across processing nodes 702A-D. For example, while one processing node compiles narrative and analytical content for a cardiovascular subsystem chapter, another node may concurrently generate renal, hepatic, metabolic, neurological, or endocrine chapters. Each processing node may execute natural language generation routines, chart-rendering engines, or subsystem-specific summarization models using its local memory 706A-D, and intermediate outputs may then be transmitted via the communication interfaces 708A-D for consolidation into a unified multi-chapter manuscript. Through this distributed synthesis, the system is capable of producing high-resolution, long-form PCPF documents containing hundreds of pages of structured physiological analysis with reduced latency and improved scalability.

In some embodiments, each processing node 702A-D may be assigned responsibility for synthesizing one or more physiological chapters, allowing the chapter-by-chapter modeling structure to be generated in parallel. For example, one processing node may generate the cardiovascular chapter while another compiles the hepatic or endocrine chapters using localized processing of the corresponding subsystem-specific data sections. This distributed chapter-level modeling approach enables large-scale manuscripts, such as 100–1000+ page PCPF documents, to be constructed efficiently, with each chapter generated from the node storing or computing on the related subsystem data. Following chapter generation, the system merges the chapters, ensuring consistency across shared biomarkers, temporal transitions, and cross-system causal pathways.

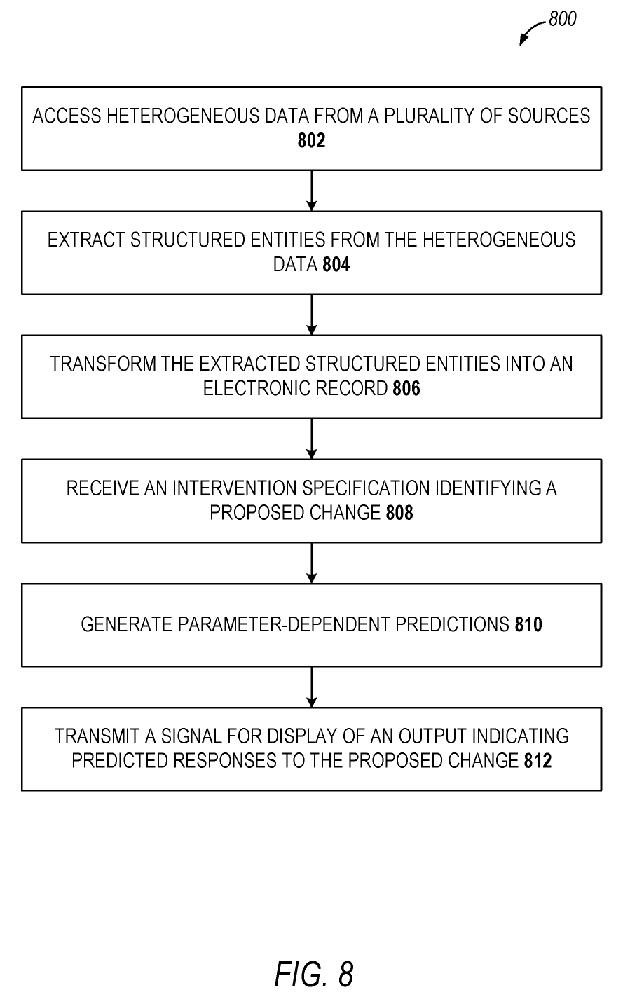

FIG. 8 is a flow chart of a technique 800 for simulation, in accordance with some embodiments.

At block 802, one or more computing devices (e.g., the distributed computing environment 602, 700) access heterogeneous data (e.g., the heterogeneous data 606) from a plurality of data sources (e.g., the data sources 604). The heterogeneous data may include at least one of laboratory test data, diagnostic imaging data, genomic or proteomic datasets, clinician notes, procedure records, medication histories, or wearable-device sensor data associated with a patient.

At block 804, the one or more computing devices extract structured entities (e.g., the structured entities 608) from the heterogeneous data. The extraction may employ at least one of optical character recognition, natural language processing, statistical analysis, or feature extraction techniques to convert unstructured or semi-structured inputs into machine-interpretable entities.

At block 806, the one or more computing devices transform, using a data normalization engine (e.g., the data normalization engine 610) stored in a memory of the one or more computing devices, the extracted structured entities into an electronic record (e.g., the electronic record 612) comprising a plurality of machine-interpretable subsystem-specific data sections (e.g., the data sections 614). Each subsystem-specific data section comprises a temporally-weighted dependency graph having nodes representing subsystem state vectors and directed edges annotated with temporal-weight coefficients. Each subsystem-specific data section corresponding to an aspect of a system and including (i) cross-subsystem temporally-weighted dependency mappings, and (ii) temporal progression data representing sequential state transitions for that subsystem. In some embodiments, transforming the structured entities includes performing ontology mapping to standardized terminology systems, performing unit conversions, resolving duplicate entities, and chronologically ordering data to produce a temporally aligned and harmonized dataset.

In some medical embodiments, the transformation may further include generating a patient-specific computational physiology file having multiple subsystem-specific data sections corresponding to physiological systems including at least one of hematologic, endocrine, immune, metabolic, hepatic, renal, cardiovascular, neurological, or gastrointestinal systems. In these medical embodiments, the cross-subsystem dependency mappings may represent causal biological relationships among the systems.

In some embodiments, the electronic record additionally includes machine-generated text describing subsystem interactions, temporal biomarker trajectories, or predicted physiological outcomes.

In some embodiments, the transformation of structured entities into subsystem-specific data sections includes a manuscript-generation phase in which the system synthesizes the long-form PCPF. Using the temporally aligned data and dependency mappings, the system produces multi-chapter narrative content describing subsystem physiology, relationships between subsystems, historical trends, risk amplifiers, and causal interactions. The manuscript may include explanatory text, graphs, tables, and dependency analyses automatically derived from the electronic record 612. Each subsystem-specific chapter may be produced using a domain-specialized natural language generation module that integrates raw quantitative data with model-inferred insights, thereby generating a human-readable but machine-verifiable representation of the system’s integrated physiological state.

In some embodiments, each subsystem-specific data section produced at block 806 is transformed into a corresponding chapter of a comprehensive physiological manuscript. The one or more computing devices construct each chapter by combining the normalized data, temporal state-transition models, dependency mappings, and subsystem-level insights generated from the structured entities 608. The chapters may include baseline subsystem assessments, temporal biomarker analyses, predictive modeling summaries, and cross-references to upstream or downstream subsystems indicated by the dependency structure. In some embodiments, each chapter follows a standardized format that includes: (i) a subsystem overview, (ii) a quantitative data interpretation layer, (iii) causal pathway and interaction mapping, (iv) predicted subsystem responses under various conditions, and (v) narrative explanation of physiological significance. This chapter-by-chapter modeling approach allows complex multi-system physiology to be modularized, while maintaining cross-chapter consistency enforced by shared dependency mappings.

At block 808, the one or more computing devices receive an intervention specification (e.g., the intervention 616) identifying a proposed change (e.g., the proposed change 618) and at least one parameter (e.g., the parameter 620) associated with the proposed change. When the intervention specification identifies a therapeutic agent, the parameter may include at least one dosage variable, and subsequent simulation may yield an intervention impact report presenting predicted dose-dependent biomarker trajectories, organ-level responses, contraindications, and safety thresholds.

In infrastructure or industrial system embodiments, the intervention may identify a proposed policy, operational change, or regulatory adjustment, and the predicted responses correspondingly indicate projected impacts on transportation, energy distribution, waste management, logistics, environmental metrics, or public-safety performance. In some embodiments, the system represents a municipal or regional infrastructure network comprising the subsystems including at least one of transportation, energy distribution, waste management, water supply, or public safety services. The intervention specification identifies a proposed policy or operational change. The predicted responses indicates projected impacts on at least one of traffic flow, resource utilization, environmental metrics, or public-service performance. In some embodiments, the system represents an industrial process that includes at least one of manufacturing, energy distribution, or logistics subsystems. The intervention specification identifies operational or regulatory adjustments to the industrial process.

In some embodiments, the system further incorporates dose-dependent pharmacokinetic and pharmacodynamic modeling that evaluates how different parameter values – such as dosage, frequency, or route of administration – affect subsystem responses over time. The pharmacokinetic component may simulate absorption, distribution, metabolism, and excretion profiles for the proposed intervention, generating predicted concentration-time curves that feed into downstream subsystem evaluations. The pharmacodynamic component may apply receptor-level interactions, saturation thresholds, sigmoidal or multiphasic response curves, and subsystem-specific sensitivity coefficients to determine how varying exposure levels modulate biological activity within each subsystem-specific data section. Together, the pharmacokinetic and pharmacodynamic models allow the system to compute dose-stratified predictions, identify nonlinear or threshold-dependent effects, and generate parameter-specific outcome profiles that are incorporated into both the consolidated intervention analysis data structure and the corresponding chapters of the long-form physiological manuscript.

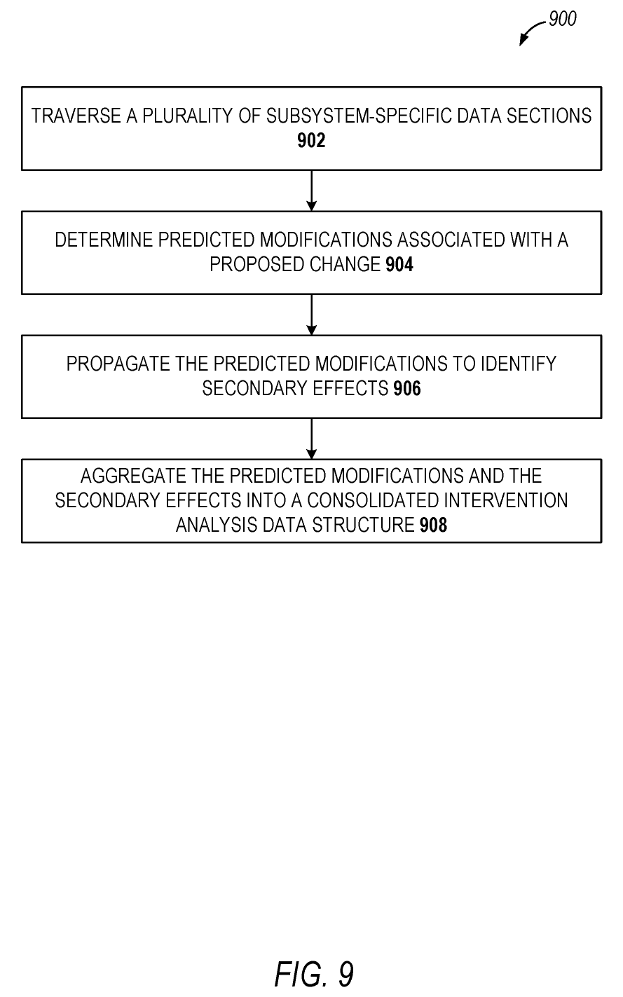

At block 810, the one or more computing devices generate using an AI model (e.g., the AI model 622) and a distributed graph-scheduled reasoning pipeline (e.g., the reasoning pipeline 624) executed across a plurality of processing nodes (e.g., the processing nodes 702A-D) configured to simulate subsystem interactions by executing subsystem-specific computations on the processing nodes assigned according to a topological ordering of the temporally-weighted dependency graph, parameter-dependent predictions. The AI model may be adaptively trained and orchestrated through the reasoning pipeline to simulate and reconcile temporal and cross-subsystem interdependencies within the electronic record. As described in greater detail in conjunction with FIG. 9, to do this, the one or more computing devices sequentially: (i) traverse the plurality of subsystem-specific data sections according to the temporally-weighted dependency graph using a weight-normalized topological traversal that determines an execution order for the distributed processing node, (ii) determine, for each subsystem-specific data section, predicted modifications associated with the proposed change while maintaining temporal causality constraints by computing updated subsystem state vectors and storing each update as a time-indexed delta entry within a delta profile tensor associated with the corresponding node of the temporally-weighted dependency graph, (iii) propagate the predicted modifications across the directed edges of the temporally-weighted dependency graph using edge-specific propagation functions stored in the memory to identify secondary effects on related subsystems, and (iv) aggregate the predicted modifications and the secondary effects into a consolidated intervention analysis data structure (e.g., the intervention analysis data structure 626) comprising, for each subsystem, a delta profile tensor including predicted time-indexed state-vector updates, confidence-metric values computed from propagation coefficients, and causal-provenance identifiers referencing the corresponding graph nodes and edges.

In some embodiments, the parameter-dependent predictions include computation of dose-response curves exhibiting linear, sigmoidal, threshold, or multiphasic relationships between intervention parameters and subsystem responses. In some embodiments, the one or more computing devices further generate a safety envelope identifying parameter ranges associated with predicted adverse subsystem responses.

In some medical embodiments, generating predicted modifications further includes adjusting subsystem responses based on patient-specific genomic or pharmacogenomic variants.

In some embodiments, a user may provide manual or user-initiated edits to the electronic record via the graphical user interface prior to generation of parameter-dependent predictions, enabling correction or supplementation of subsystem-specific information.

At block 812, the one or more computing devices transmit (e.g., to the display device 630) a signal for display of an output (e.g., the visual output 628) indicating predicted responses of the system to the proposed change. The output includes a representation of the consolidated intervention analysis data structure via a graphical user interface (e.g., presented via the display device 630) that enables a user to visualize predicted subsystem responses, explore alternative intervention scenarios, and compare predicted outcomes generated using the delta profile tensors and causal-provenance identifiers stored within the temporally-weighted dependency graph. Comparing the predicted outcomes may support decision making related to the proposed change based on the temporally-indexed delta profile and the cross-subsystem confidence metrics.

In some embodiments, the one or more computing devices generate an intervention impact report that organizes the simulation results into a structured, multi-layered format designed for interpretability and cross-subsystem comparison. The report may include an executive summary highlighting key predicted outcomes, followed by parameter-specific sections presenting dose-stratified biomarker trajectories, subsystem-level response curves, safety envelopes, and identified risk regions. Additional sections may present cross-system causal chains derived from the dependency mappings, temporal progression graphs illustrating predicted state transitions, and confidence-metric panels summarizing uncertainty estimates for each subsystem prediction. The report may further include tables comparing baseline versus post-intervention physiological states, visualizations depicting secondary or cascading effects, and provenance indicators linking each prediction to source data and model pathways. The structured design allows clinicians or system operators to review both high-level and subsystem-specific impacts, enabling more informed decision-making across multiple intervention scenarios.

In some embodiments, the graphical interface presents scenario comparisons for infrastructure or industrial systems, enabling evaluation of projected impacts on transportation flow, energy distribution balance, waste-management throughput, water-supply stability, logistics routing, or public-safety metrics.

In some embodiments, the cross-subsystem dependency mappings (generated at block 810) are represented using directed acyclic graphs (DAGs) modeling causal relationships among subsystems. In such embodiments, each node of the DAG corresponds to a subsystem-specific data section (e.g., a physiological system, an industrial subsystem, or an infrastructure component), and each directed edge represents a causal or influence relationship through which changes in an upstream subsystem may propagate to one or more downstream subsystems. The absence of cycles in the DAG ensures that the system maintains a well-defined, non-recursive ordering of influence paths, allowing the AI model and the reasoning pipeline to evaluate predicted modifications in a manner that respects temporal causality and hierarchical dependency structures.

During simulation, the AI model may traverse the DAG in topologically sorted order to identify upstream subsystems whose predicted modifications must be computed before evaluating the dependent downstream subsystems. When the model determines predicted modifications for an upstream subsystem, those modifications are stored in association with the corresponding node and are then propagated along outgoing edges to the affected downstream nodes, where they are combined with local subsystem data and temporal progression information to compute secondary or cascading effects. In some embodiments, edge weights encode the strength, directionality, or conditionality of causal influence, allowing the reasoning pipeline to modulate the magnitude of propagated effects based on subsystem-specific parameters, empirical coefficients, or historical correlation patterns.

The DAG structure further allows the system to detect and isolate independent branches of subsystem interactions, enabling localized predictions to proceed in parallel where no dependency relationship exists. Conversely, for convergent branches, where multiple upstream subsystems influence a common downstream subsystem, the DAG provides the framework for reconciling multiple incoming predicted modifications using rule-based aggregation, statistical fusion, or learned combination functions. By employing a DAG as the structural representation of cross-subsystem dependencies, the simulation process maintains internal consistency, prevents infinite feedback loops, and facilitates efficient decomposition of complex interdependent behavior across multiple subsystems.

FIG. 9 is a flow chart of a technique 900 for processing predicted modification and secondary effects in a simulation, in accordance with some embodiments. The technique 900 may be performed by the one or more computing devices in conjunction with block 810 of FIG. 8.

At block 902, the one or more computing devices traverse the plurality of subsystem-specific data sections according to the temporally-weighted dependency graph using a weight-normalized topological traversal that determines an execution order for the distributed processing node. In some embodiments, the dependency mappings are encoded as a DAG, where each node corresponds to a subsystem and each directed edge represents a causal influence pathway. The DAG structure enables the computing devices to perform a topological ordering of the subsystem-specific data sections, ensuring that upstream subsystems are evaluated before downstream subsystems whose behavior depends on the upstream predictions. This ordering prevents recursive propagation loops and preserves temporal causality during simulation.

The DAG also allows the system to identify independent branches of the dependency graph that may be evaluated concurrently, enabling subsystem-level computations to be executed in parallel on distributed or specialized hardware such as GPUs or individual processing nodes (e.g., the processing nodes 702A-D) of a distributed computing environment (e.g., the distributed computing environment 700), thereby accelerating evaluation of complex or high-dimensional data sections.

At block 904, the one or more computing devices determine, for each subsystem-specific data section, predicted modifications associated with the proposed change while maintaining temporal causality constraints by computing updated subsystem state vectors and storing each update as a time-indexed delta entry within a delta profile tensor associated with the corresponding node of the temporally-weighted dependency graph. As each data section may include temporal progression data and sequential state-transition models, the one or more computing devices may incorporate time-indexed predictions and may apply subsystem-specific rules, statistical models, or learned functions to compute local changes. In embodiments employing a DAG, predicted modifications are stored at the corresponding node in the graph and become the basis for downstream propagation once the local evaluation is complete.

In some embodiments, the system may update the electronic record dynamically when newly acquired data becomes available (e.g., updated laboratory values or newly processed sensor measurements) and subsequently re-execute the local and downstream evaluations to regenerate a refined intervention analysis data structure. Over time, the AI model may incorporate reinforcement learning mechanisms that adjust its prediction functions based on the accuracy of prior simulations, thereby improving predictive fidelity.

In some embodiments, the predicted modifications computed during the traversal of the subsystem-specific data sections are incorporated into the PCPF manuscript as model-generated commentary describing the expected system behavior under the proposed change. These narrative updates may include subsystem-by-subsystem explanations of predicted effects, temporal evolution of modifications, causal justifications using dependency-mapping logic, and qualitative summaries linking upstream changes to downstream consequences. The system may embed these narratives directly into the corresponding chapters of the long-form PCPF, thereby extending the manuscript to not only describe the baseline physiological state but also predicted outcomes associated with the simulated intervention.

At block 906, the one or more computing devices propagate the predicted modifications across the directed edges of the temporally-weighted dependency graph using edge-specific propagation functions stored in the memory to identify secondary effects on related subsystems. In embodiments employing a DAG, propagation proceeds along the directed edges such that effects flow from each evaluated node to its successors. Edge attributes may encode weighting factors, conditional triggers, or transformation functions specifying how upstream modifications alter downstream subsystem states. When multiple upstream nodes converge on a single downstream node, the computing devices reconcile the incoming propagated values using rule-based fusion, probabilistic inference, or learned combination functions. This graph-based propagation enables systematic modeling of cascading or amplifying subsystem interactions, as well as bounded termination because the acyclic structure ensures that propagation cannot re-enter an already-processed node.

At block 908, the one or more computing devices aggregate the predicted modifications and the secondary effects into a consolidated intervention analysis data structure (e.g., the intervention analysis data structure 626) comprising, for each subsystem, a delta profile tensor including predicted time-indexed state-vector updates, confidence-metric values computed from propagation coefficients, and causal-provenance identifiers referencing the corresponding graph nodes and edges. The delta profile may be a temporally-indexed delta profile, cross-subsystem confidence metrics, and provenance metadata linking predictions to underlying data sources. In some embodiments, the aggregation operation also captures intermediate DAG-level computation states, including the ordering of traversal, dependency-resolution paths, and uncertainty propagation across edges. The resulting analysis data structure may further be used to support incremental recomputation when new or revised data triggers partial reevaluation of only affected nodes in the DAG, enabling efficient dynamic updating of predictions. The recomputation may occur in response to receipt of the new or revised data.

In some embodiments, the consolidated intervention analysis data structure generated at block 908 is incorporated into the chapter-by-chapter physiological model by updating each relevant chapter with predicted modifications and secondary effects. For each subsystem, the system appends or replaces content within the corresponding chapter to include projected biomarker trajectories, subsystem response curves, causal reasoning summaries, and explanatory text linking upstream changes to downstream physiological consequences. This produces an updated, simulation-aware version of each chapter, enabling the PCPF to serve not only as a baseline physiological model but also as a dynamically updated representation of predicted responses to interventions.

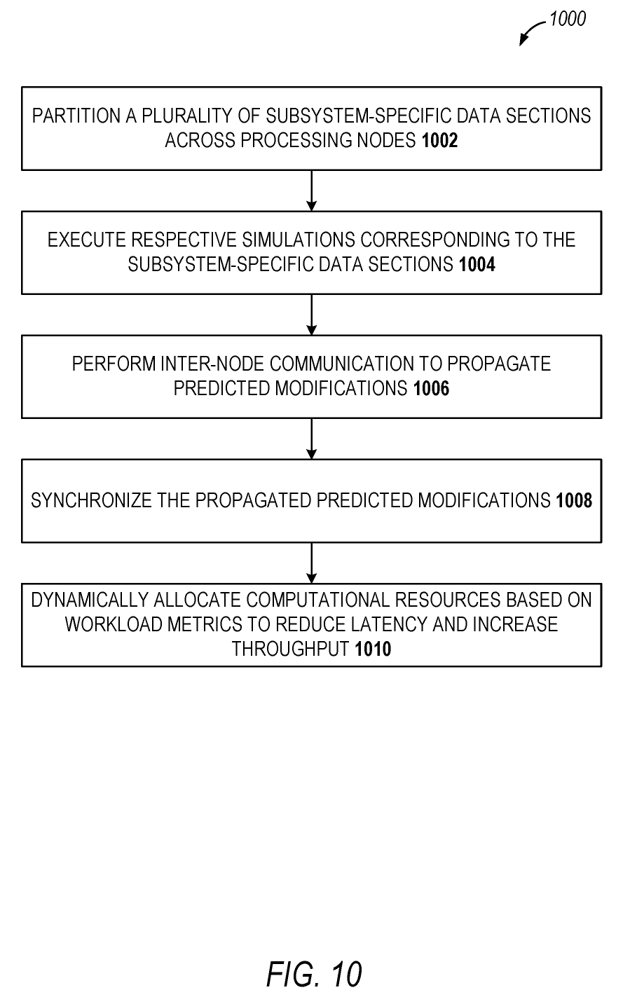

FIG. 10 is a flow chart of a technique 1000 for allocating computing resources for simulation within a distributed computing environment (e.g., the distributed computing environment 700), in accordance with some embodiments. The technique 1000 may be performed by the one or more computing devices in conjunction with the technique 800 of FIG. 8. The one or more computing devices may operate within a distributed computing environment (e.g., the distributed computing environment 700) comprising a plurality of processing nodes (e.g., the processing nodes 702A-D), each processing node (e.g., the processing node 702A) including at least one processor (e.g., the processor 704A) and a local memory (e.g., the memory 706A). In some embodiments, at least one of the processing nodes may additionally include specialized accelerators such as GPUs or tensor processing units configured to accelerate subsystem-specific operations such as radiomics extraction, natural language processing, or high-dimensional statistical inference. The distributed environment accordingly enables scalable execution of computationally intensive simulations by distributing subsystem workloads across hardware resources that operate concurrently.

At block 1002, the one or more computing devices partition the plurality of subsystem-specific data sections across the processing nodes of the distributed computing environment based on data dependencies indicated by the cross-subsystem dependency mappings. In embodiments where the dependency mappings are represented as a DAG, the one or more computing devices may identify independent or weakly coupled branches of the DAG and assign each branch to a separate processing node, thereby minimizing the frequency of inter-node communication. Subsystems with strong mutual dependencies may be co-located on the same node to reduce synchronization overhead derived from repeatedly exchanging intermediate results. Partitioning may also consider subsystem size, temporal resolution, and predicted computational cost, enabling balance across processing nodes and preventing bottlenecks caused by assigning disproportionately heavy workloads to a single node.

At block 1004, the one or more computing devices execute, in parallel across the processing nodes, respective simulations corresponding to the subsystem-specific data sections. Each processing node evaluates predicted modifications for the data sections assigned to it, using the local memory to store intermediate results and temporary model states. Parallel execution allows independent branches of the DAG to be processed simultaneously, significantly reducing the time required to complete the overall simulation. The one or more computing devices may additionally pipeline sequential DAG layers such that once an upstream node completes its local simulation, downstream nodes can begin their computations even while other upstream evaluations are still in progress.

At block 1006, the one or more computing devices perform inter-node communication to propagate predicted modifications between processing nodes representing interdependent subsystems. For subsystems connected by DAG edges that span node boundaries, the upstream node transmits its predicted modifications, along with any associated uncertainty estimates or temporally indexed deltas, to the downstream node. This communication may occur using low-latency channels implemented through the communication interfaces (e.g., the communication interfaces 708A-D). In some embodiments, the one or more computing devices batch multiple updates to reduce communication overhead, or prioritizes certain update pathways based on causal significance or time-criticality as indicated by dependency weights in the DAG.

At block 1008, the one or more computing devices synchronize the propagated predicted modifications to generate the consolidated intervention analysis data structure. Synchronization may ensure that downstream processing nodes do not finalize their subsystem-specific predictions until all relevant upstream updates have been received and incorporated. In some embodiments, the system performs a global barrier synchronization after each DAG layer completes its computations, while in other embodiments a more granular, dependency-aware synchronization scheme is used, allowing nodes whose dependencies have resolved early to proceed without waiting for other unrelated branches of the graph. The synchronization operation may ensure consistency of the consolidated intervention analysis data structure, preventing stale or partial propagation results from influencing final outcomes.

In some embodiments, the synchronization of predicted modifications across processing nodes further enables coordinated generation of the corresponding sections of the PCPF manuscript. Once all relevant subsystem predictions have been reconciled, the system may initiate a distributed manuscript-generation process in which each processing node compiles updated narrative content, visualizations, and explanatory summaries for the subsystems under its control. These chapter fragments are then merged into a unified PCPF document, with cross-referencing, figure numbering, causal-chain explanations, and system-wide interpretation automatically generated as part of the final assembly. Through this coordinated synthesis, the system produces a comprehensive long-form manuscript reflecting both the baseline subsystem analyses and the predicted intervention-driven modifications.

At block 1010, the one or more computing devices dynamically allocate computational resources based on workload metrics to reduce latency and increase throughput during generation of the parameter-dependent predictions. Workload metrics may include processor utilization, memory consumption, queue lengths, graph centrality measures indicating subsystem importance, or predicted computational complexity derived from subsystem size or dimensionality. Based on these metrics, the one or more computing devices may migrate subsystem data sections between processing nodes, spawn additional processing nodes in a cloud computing environment, or reassign tasks to hardware accelerators to improve throughput. In some embodiments, dynamic allocation is informed by reinforcement learning policies that observe historical patterns of computational demand and adaptively select resource allocation strategies. In this way, the distributed environment maintains efficient operation even when subsystem workloads change due to new data ingestion, high-dimensional analyses, or complex cross-system propagation behavior.

In some embodiments, the dynamic allocation of computational resources described at block 1010 further enhances the chapter-by-chapter physiological modeling process. Chapters requiring high-dimensional computation – such as genomic, imaging-derived, or metabolic modeling chapters – may be routed to processing nodes with greater GPU capacity, while text-heavy or logic-dense chapters may be assigned to CPU-optimized nodes. The one or more computing devices may continuously rebalance chapter workloads across nodes based on real-time metrics such as processor utilization, memory demand, or predicted chapter generation time. By aligning hardware capabilities with chapter-specific computational profiles, the one or more computing devices sustain high throughput even for manuscripts exceeding several hundred pages.

In some embodiments, the cross-subsystem dependency mappings are not limited to directed acyclic graphs. For example, a non-DAG dependency structure may be employed when the modeled system includes cyclical or feedback-driven relationships that cannot be represented using strictly acyclic graphs. In these embodiments, the system may use directed cyclic graphs or recurrent dependency models in which edges may form closed loops corresponding to real-world feedback mechanisms (e.g., regulatory feedback in physiological systems, load-control feedback in energy grids, or proportional integral derivative (PID) style control loops in industrial processes). To prevent infinite propagation within such cycles, the reasoning pipeline may apply bounded iteration rules, decay factors, convergence thresholds, or temporal gating that modulate repeated evaluations until the predicted subsystem states satisfy specified stability or tolerance criteria. This enables simulation of dynamic environments in which subsystem responses evolve through mutually reinforcing or compensatory interactions, rather than through purely feed-forward cascades.

In some embodiments, the dependency mappings are represented as probabilistic graphs, such as Bayesian networks, conditional random fields, or probabilistic graphical models. In these embodiments, each edge connecting two subsystems includes a probability distribution, conditional dependency rule, or joint likelihood function describing the statistical strength or uncertainty of the causal influence. During simulation, predicted modifications may be propagated according to inferred posterior distributions, and downstream subsystem predictions may incorporate uncertainty quantification, confidence intervals, or variance estimates derived from the probabilistic model. This allows the system to simulate environments where causal relationships are uncertain, noisy, or partially observable, and to provide risk-aware or confidence-weighted predictions in the consolidated intervention analysis data structure. In certain embodiments, the system may dynamically update the probabilistic dependencies using online learning or Bayesian updating when new data becomes available, allowing the dependency graph to adapt over time.

In another set of embodiments, the distributed computing environment employs hybrid GPU/CPU scheduling strategies to optimize simulation performance. Subsystem-specific operations that involve matrix computation, tensor operations, image feature extraction, sequence modeling, or high-dimensional statistical inference may be scheduled on GPUs or tensor accelerators, while operations involving symbolic reasoning, rule-based aggregation, or non-vectorizable control logic may be executed on CPUs. A scheduling engine may monitor subsystem computational characteristics, such as workload type, data dimensionality, predicted compute time, or memory bandwidth requirements, and determine whether a given subsystem’s simulation should be executed on CPU or GPU resources. In some embodiments, the scheduling engine may migrate subsystem workloads between CPU and GPU resources mid-simulation in response to evolving workload metrics or hardware utilization patterns. This hybrid scheduling approach allows the system to accelerate computationally intensive tasks while maintaining flexibility for subsystem evaluations better suited to CPU execution.

In embodiments involving hybrid GPU/CPU scheduling, the system may further employ asynchronous execution pipelines in which GPU and CPU tasks operate concurrently and communicate through shared memory buffers or message-passing interfaces. This allows downstream subsystems to begin processing as soon as upstream GPU tasks produce partial outputs, without requiring full synchronization across all nodes. In some embodiments, GPU kernels may be specialized or fused to efficiently compute batched subsystem updates, while CPU threads simultaneously evaluate rule-based or temporal-causality logic for other branches of the dependency graph. By combining heterogeneous computing resources in this manner, the system achieves improved performance, reduced latency, and scalable throughput across varying simulation scenarios and subsystem complexities.

In other embodiments, the one or more computing devices may employ adaptive graph restructuring, where the dependency model itself – whether represented as a DAG, cyclic graph, or probabilistic graph – is temporarily reorganized during simulation to improve computational efficiency. For example, the one or more computing devices may cluster strongly connected subsystems into composite nodes, reorder exploratory branches based on predicted computational cost, or prune edges whose influence weights fall below a dynamic threshold. Such restructuring may be performed at simulation initialization or periodically during execution, enabling the computing environment to adapt to changing data characteristics or computational constraints without compromising prediction fidelity.

In some medical embodiments, the heterogeneous data 606 accessed by the AI system 600 encompasses an expanded range of clinical and biological data sources beyond laboratory test data, diagnostic imaging data, and genomic datasets. In these embodiments, the data sources 604 may further include hospital discharge summaries, problem lists, diagnosis histories, medication lists, and operative notes. Hospital discharge summaries provide temporally concentrated snapshots of inpatient encounters, including admission diagnoses, treatment courses, procedures performed, and discharge instructions. Problem lists and diagnosis histories aggregate longitudinal records of a patient’s active and historical conditions, enabling the system to construct a chronological view of medical events that inform the cross-subsystem dependency mappings. Operative notes document surgical interventions and procedural details at a granularity that supports subsystem-specific modeling of tissue-level or organ-level changes resulting from prior interventions.

In some embodiments, the heterogeneous data 606 further comprises metabolomic data, microbiome data, and epigenomic datasets. Metabolomic data includes quantified small-molecule profiles derived from biological samples such as blood, urine, or tissue, enabling the system to model metabolic flux, substrate availability, and pathway activity within the metabolic subsystem-specific data sections. Microbiome data comprises taxonomic and functional profiles of microbial communities inhabiting the gastrointestinal tract or other body sites, allowing the AI system 600 to incorporate microbiome-derived metabolic pathways into subsystem evaluations. For example, when evaluating predicted modifications associated with a proposed therapeutic intervention, the AI model 622 may determine how changes to the gut microbiome composition influence downstream metabolic, immune, or neurological subsystems through microbial metabolite production, immune modulation, or gut-brain axis signaling. Epigenomic datasets include DNA methylation profiles, histone modification maps, or chromatin accessibility data that may modulate gene expression and thereby influence subsystem-level responses to therapeutic interventions.

In some embodiments, the heterogeneous data 606 further includes specific categories of wearable-device sensor data, including heart rate measurements, heart rate variability (HRV) data, respiration rate and pattern data, and continuous glucose monitoring profiles. Heart rate and HRV data may be used to assess cardiovascular function, autonomic nervous system balance, and stress responses. Respiration data may inform pulmonary function assessment and cardiopulmonary integration modeling. Continuous glucose profiles may be integrated into metabolic and endocrine subsystem modeling to characterize glycemic variability, insulin sensitivity, and metabolic homeostasis.

In some embodiments, the heterogeneous data 606 includes oncological laboratory reports comprising tumor markers, circulating tumor cell counts, cancer antigen levels, and other oncology-specific biomarkers. Oncological laboratory data may be integrated into immune, hematologic, and organ-specific subsystem chapters to model cancer-related physiological alterations and to evaluate how proposed interventions may interact with oncological conditions or treatments.

In some embodiments, the diagnostic imaging data within the heterogeneous data 606 includes nuclear medicine imaging, such as positron emission tomography (PET), single-photon emission computed tomography (SPECT), and other radionuclide-based imaging modalities. Nuclear medicine imaging data may provide functional and metabolic information complementing anatomical imaging from at least one of computed tomography (CT), magnetic resonance imaging (MRI), x-ray, or ultrasound studies. The system may extract quantitative parameters from nuclear medicine studies, including standardized uptake values, perfusion indices, and metabolic activity measurements, for incorporation into relevant subsystem-specific data sections.

In some embodiments, the entity extraction operations performed by the AI system 600 include extraction of physician narrative interpretations from clinical documentation. Physician narrative interpretations include clinical judgments, diagnostic reasoning, prognostic assessments, and treatment rationales documented by clinicians in consultation notes, progress notes, discharge summaries, and other narrative records. The extracted physician narrative interpretations may be incorporated into the PCPF as contextual information informing subsystem assessments, may be cross-referenced with quantitative biomarker data, and may be used to resolve ambiguities in automated entity extraction.

In some embodiments, the entity extraction operations performed by the AI system 600 include additional processing techniques to handle diverse medical data modalities. In addition to optical character recognition, natural language processing, radiomics feature extraction, and genomic variant parsing described herein, the system may employ named entity recognition (NER) to identify and classify clinically relevant entities within unstructured text, including medication names, dosage specifications, anatomical references, symptom descriptors, and temporal expressions. The AI system 600 may further employ medical terminology parsers configured to interpret domain-specific vocabularies, abbreviations, and notational conventions commonly appearing in clinical documentation. These parsers may resolve ambiguous terms, expand abbreviations, and map extracted entities to standardized ontologies for downstream harmonization.

In some embodiments, the data ingestion operations support additional file formats beyond the formats described herein. For example, the Multi-Modal Data Ingestion Layer may accept TIFF (tagged image file format) image files (or other image files) commonly used in pathology or radiological archives, DOCX document files (or other word processing files) including clinical reports or consultation notes, and proprietary vendor formats produced by specialized medical devices, laboratory analyzers, or electronic health record systems. The system may employ format-specific adapters or transformation modules to convert these additional formats into intermediate representations suitable for entity extraction and normalization.

In some embodiments, the structured entities 608 produced by the entity extraction operations are harmonized to additional standardized terminologies and ontologies. In particular, genetic variants may be expressed using Human Genome Variation Society (HGVS) notation or may be derived from Variant Call Format (VCF) files produced by genomic sequencing pipelines. Procedures may be encoded using Current Procedural Terminology (CPT) codes in addition to or in place of SNOMED-CT procedure codes. The harmonization process ensures that extracted entities from heterogeneous sources are mapped to unified identifiers, enabling cross-subsystem dependency mappings to accurately link related entities regardless of their original source format or notation.

In some medical embodiments, the PCPF includes additional dedicated chapters corresponding to specialized physiological domains. In particular, the PCPF may include a Toxicology and Environmental Exposure Modeling chapter that analyzes environmental toxicant exposures, occupational chemical contacts, heavy metal accumulations, and their effects on organ function, detoxification pathways, and systemic health. This chapter integrates structured entities derived from toxicology laboratory panels, exposure questionnaires, environmental sensor data, and clinical documentation of suspected or confirmed toxic exposures. The toxicology chapter may further model interactions between toxicological burdens and other physiological subsystems, such as hepatic detoxification capacity, renal clearance efficiency, neurological vulnerability, and immune sensitization.

In some embodiments, the PCPF further includes a Data Integrity Review section or chapter documenting source provenance, extraction confidence levels, uncertainty rankings, and identified data quality issues. This section may catalog conflicting laboratory values, ambiguous clinical information, missing data fields, or discrepancies between data sources, enabling clinicians or system operators to assess the reliability of the underlying data informing subsystem-specific analyses and intervention simulations. The Data Integrity Review section may further include automated assessments of data completeness, temporal coverage, and cross-source consistency, providing a structured foundation for interpreting the confidence and limitations of model-generated predictions.

In some medical embodiments, the intervention 616 evaluated by the Intervention Simulation Engine encompasses an expanded range of therapeutic agents and modifiers beyond pharmaceutical compounds. In particular, the intervention 616 may include biologics, such as monoclonal antibodies, therapeutic proteins, or cell-based therapies, which may exhibit distinct pharmacokinetic and pharmacodynamic properties compared to small-molecule drugs. The intervention 616 may further include nutraceuticals, such as dietary supplements, functional foods, or botanical extracts, whose effects on physiological subsystems may be modeled using dose-dependent response curves derived from preclinical, clinical, or mechanistic data. The intervention 616 may additionally include supplements, such as vitamins, minerals, amino acids, or fatty acid formulations, and hormonal therapies, such as hormone replacement, thyroid supplementation, or corticosteroid administration. In some embodiments, the intervention 616 may include lifestyle or environmental modifiers, such as dietary interventions, exercise regimens, sleep modifications, or environmental exposure reductions, whose effects on physiological subsystems may be simulated using subsystem-specific response models.

In some embodiments, the Intervention Simulation Engine performs a structured simulation process comprising distinct operational phases. The process may include a Dose Initialization phase in which the system configures simulation parameters based on the specified candidate doses, routes of administration, and dosing schedules. The process may further include a Subsystem Mechanistic Matching phase in which the AI model 622 identifies, for each subsystem-specific data section, the relevant mechanistic pathways, receptor interactions, enzyme activities, or biological targets through which the candidate intervention is expected to exert effects. This matching operation may employ neural network-based pattern matching against a library of known mechanistic responses, enabling the system to identify established biological mechanisms corresponding to the specified intervention and patient-specific subsystem states. The process may additionally include a Detection of Contradictions or Amplifications phase in which the system identifies subsystem interactions that produce conflicting effects (e.g., opposing receptor modulation or antagonistic pathway activation) or amplification cascades (e.g., synergistic cross-system effects or positive feedback loops) resulting from the proposed intervention.

In some embodiments, the subsystem-specific modeling performed by the Intervention Simulation Engine incorporates analysis of additional mechanistic domains. The modeling may include receptor pathway analysis, in which the system evaluates how the candidate intervention modulates receptor-ligand interactions, downstream signaling cascades, and receptor-mediated cellular responses within each affected subsystem. The modeling may further include hormonal modulation analysis, in which the system predicts how the intervention influences hormone synthesis, secretion, transport, receptor binding, and feedback regulation across endocrine-related subsystem-specific data sections. The modeling may additionally include detoxification and metabolic conversion analysis, in which the system evaluates how the intervention is processed by hepatic enzymes, conjugation pathways, and excretion mechanisms, and how these processes interact with baseline detoxification capacity and other concurrent exposures.

In some embodiments, the subsystem-specific modeling further includes immune activation or suppression analysis, in which the system predicts how the intervention modulates immune cell populations, cytokine profiles, inflammatory mediators, or immunoregulatory pathways. The modeling may include neuromodulation analysis, in which the system evaluates how the intervention affects neurotransmitter synthesis, release, reuptake, receptor activation, or neural circuit function within neurological subsystem-specific data sections. The modeling may further include organ stress and reserve shift analysis, in which the system predicts how the intervention alters organ-level functional capacity, compensatory reserves, stress responses, or vulnerability to additional perturbations.

In some embodiments, the Intervention Impact Report generated by the AI system 600 includes additional structured content beyond dose-response curves, predicted biomarker changes, and system-level summaries. In particular, the report may include a summary of beneficial, neutral, and adverse effects organized by subsystem, enabling clinicians or system operators to distinguish between subsystems expected to improve, remain stable, or deteriorate under the proposed intervention. The report may further include suggested monitoring strategies specifying laboratory tests, imaging studies, clinical assessments, or wearable sensor measurements recommended for tracking subsystem responses and detecting early indicators of adverse effects. The report may additionally include recommendations for dose optimization identifying parameter ranges, dosing schedules, or administration routes predicted to maximize therapeutic benefit while minimizing adverse subsystem impacts or cross-system risks.

In some embodiments, the Intervention Impact Report includes identification of risk regions and unsafe dose ranges derived from the subsystem-specific simulation results. Risk regions may correspond to dose-parameter combinations associated with predicted biomarker excursions beyond clinically acceptable thresholds, organ-level toxicity indicators, or amplified cross-system adverse effects. The report may present these risk regions using visual representations such as heat maps, safety envelopes, or parameter-space diagrams, enabling users to identify intervention configurations predicted to produce unacceptable risk profiles.

In some embodiments, the AI system 600 further includes a validation module configured to compare simulated outputs against stored clinical outcomes for similar interventions. The validation module may access historical outcome data, clinical trial results, or real-world evidence databases to identify prior instances in which comparable interventions were administered to patients with similar physiological profiles. The module may then compare the predicted subsystem responses generated by the Intervention Simulation Engine against the observed clinical outcomes from these historical instances, producing validation metrics, accuracy assessments, or calibration indicators that inform confidence in the current simulation results. In some embodiments, the validation module may employ the comparison results to refine predictive accuracy through feedback-driven model updating or reinforcement learning.

Some embodiments are described as numbered examples (Example 1, 2, 3, etc.). These are provided as examples only and do not limit the technology disclosed herein.

Example 1 is a method comprising: accessing, by one or more computing devices, heterogeneous data from a plurality of data sources; extracting, by the one or more computing devices, structured entities from the heterogeneous data; transforming, using a data normalization engine executed by the one or more computing devices, the extracted structured entities into an electronic record comprising a plurality of machine-interpretable subsystem-specific data sections stored in a memory, each subsystem-specific data section comprising a temporally-weighted dependency graph having nodes representing subsystem state vectors and directed edges annotated with temporal-weight coefficients; receiving, by the one or more computing devices, an intervention specification identifying a proposed change and at least one parameter associated with the proposed change; generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially: traversing the plurality of subsystem-specific data sections according to the temporally-weighted dependency graph using a weight-normalized topological traversal that determines an execution order for the distributed processing node, determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph, propagating the predicted modifications across the directed edges of the temporally-weighted dependency graph using edge-specific propagation functions stored in the memory to identify secondary effects on related subsystems, and aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.

In Example 2, the subject matter of Example 1 includes, wherein the heterogeneous data comprise at least one of laboratory test data, diagnostic imaging data, genomic or proteomic datasets, clinician notes, procedure records, medication histories, or wearable-device sensor data associated with a patient.

In Example 3, the subject matter of Examples 1–2 includes, wherein transforming the extracted structured entities into the electronic record comprises: generating a patient-specific computational physiology file including a plurality of subsystem-specific data sections corresponding to physiological systems comprising at least one of hematologic, endocrine, immune, metabolic, hepatic, renal, cardiovascular, neurological, or gastrointestinal systems, and wherein the dependency graph indicates causal biological relationships among the physiological systems.

In Example 4, the subject matter of Examples 1–3 includes, wherein the intervention specification identifies a therapeutic agent and at least one dosage parameter, and wherein the output comprises an intervention impact report presenting, for each dosage parameter, predicted dose-dependent biomarker trajectories, organ-level responses, contraindications, and safety thresholds derived from the consolidated intervention analysis data structure.

In Example 5, the subject matter of Examples 1–4 includes, wherein transforming the extracted structured entities into the electronic record comprises: performing ontology mapping to a standardized terminology system; performing unit conversions; resolving duplicate entities; and ordering data chronologically to generate a temporally aligned and harmonized dataset.

In Example 6, the subject matter of Examples 1–5 includes, wherein generating the parameter-dependent predictions comprises: executing subsystem evaluations in parallel across distributed computing resources, including graphics processing units configured to accelerate radiomics feature extraction and natural language processing workloads.

In Example 7, the subject matter of Examples 1–6 includes, dynamically updating the electronic record and regenerating the consolidated intervention analysis data structure in response to receipt of new or revised data from one or more data sources, wherein the artificial intelligence model employs reinforcement learning to refine predictive accuracy based on prior simulation outcomes.

In Example 8, the subject matter of Examples 1–7 includes, wherein the electronic record further comprises machine-generated text describing at least one of subsystem interactions, temporal biomarker trajectories, or predicted physiological outcomes.

In Example 9, the subject matter of Examples 1–8 includes, wherein the dependency graph comprises a directed acyclic graph modeling causal relationships among subsystems.

In Example 10, the subject matter of Examples 1–9 includes, wherein generating the parameter-dependent predictions comprises: computing dose-response curves representing linear, sigmoidal, or multiphasic relationships between intervention parameters and subsystem responses.

In Example 11, the subject matter of Examples 1–10 includes, wherein the output further comprises a safety envelope identifying parameter ranges associated with predicted adverse subsystem responses.

In Example 12, the subject matter of Examples 1–11 includes, wherein generating predicted modifications further comprises adjusting subsystem responses based on patient-specific genomic or pharmacogenomic variants.

In Example 13, the subject matter of Examples 1–12 includes, receiving user-initiated edits to the electronic record through the graphical user interface prior to generating the parameter-dependent predictions.

In Example 14, the subject matter of Examples 1–13 includes, wherein the one or more computing devices operate within a distributed computing environment comprising a plurality of processing nodes, each processing node including at least one processor and a local memory, the method further comprising: partitioning the plurality of subsystem-specific data sections across the processing nodes based on data dependencies indicated by the dependency graph; executing, in parallel across the processing nodes, respective simulations corresponding to the subsystem-specific data sections; performing inter-node communication to propagate predicted modifications between processing nodes representing interdependent subsystems; synchronizing the propagated predicted modifications to generate the consolidated intervention analysis data structure; and dynamically allocating computational resources based on workload metrics to reduce latency and increase throughput during generation of the parameter-dependent predictions.

In Example 15, the subject matter of Examples 1–14 includes, wherein the heterogeneous data represent a municipal or regional infrastructure network comprising the subsystems including at least one of transportation, energy distribution, waste management, water supply, or public safety services, and wherein the intervention specification identifies a proposed policy or operational change, the predicted responses indicating projected impacts on at least one of traffic flow, resource utilization, environmental metrics, or public-service performance.

In Example 16, the subject matter of Examples 1–15 includes, wherein the heterogenous data represent an industrial process comprising at least one of manufacturing, energy distribution, or logistics subsystems, and wherein the intervention specification identifies operational or regulatory adjustments to the industrial process.

In Example 17, the subject matter of Examples 1–16 includes, wherein extracting the structured entities comprises using at least one of optical character recognition, natural language processing, statistical analysis, or feature extraction techniques.

Example 18 is a non-transitory computer-readable medium storing instructions operable to cause one or more computing devices to perform operations comprising: accessing, by the one or more computing devices, heterogeneous data from a plurality of data sources; extracting, by the one or more computing devices, structured entities from the heterogeneous data; transforming, using a data normalization engine executed by the one or more computing devices, the extracted structured entities into an electronic record comprising a plurality of machine-interpretable subsystem-specific data sections stored in a memory, each subsystem-specific data section comprising a temporally-weighted dependency graph having nodes representing subsystem state vectors and directed edges annotated with temporal-weight coefficients; receiving, by the one or more computing devices, an intervention specification identifying a proposed change and at least one parameter associated with the proposed change; generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially: traversing the plurality of subsystem-specific data sections according to the temporally-weighted dependency graph using a weight-normalized topological traversal that determines an execution order for the distributed processing node, determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph, propagating the predicted modifications across the directed edges of the temporally-weighted dependency graph using edge-specific propagation functions stored in the memory to identify secondary effects on related subsystems, and aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.

In Example 19, the subject matter of Example 18 includes, wherein the heterogeneous data comprise at least one of laboratory test data, diagnostic imaging data, genomic or proteomic datasets, clinician notes, procedure records, medication histories, or wearable-device sensor data associated with a patient.

Example 20 is a system comprising: one or more processors; and a memory storing instructions operable to cause the one or more processors to perform operations comprising: accessing, by one or more computing devices, heterogeneous data from a plurality of data sources; extracting, by the one or more computing devices, structured entities from the heterogeneous data; transforming, using a data normalization engine executed by the one or more computing devices, the extracted structured entities into an electronic record comprising a plurality of machine-interpretable subsystem-specific data sections stored in the memory, each subsystem-specific data section comprising a temporally-weighted dependency graph having nodes representing subsystem state vectors and directed edges annotated with temporal-weight coefficients; receiving, by the one or more computing devices, an intervention specification identifying a proposed change and at least one parameter associated with the proposed change; generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially: traversing the plurality of subsystem-specific data sections according to the temporally-weighted dependency graph using a weight-normalized topological traversal that determines an execution order for the distributed processing node, determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph, propagating the predicted modifications across the directed edges of the temporally-weighted dependency graph using edge-specific propagation functions stored in the memory to identify secondary effects on related subsystems, and aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms "a" or "an" are used, as is common in patent documents, to include one or more than one, independent of any other instances or usages of "at least one" or "one or more." In this document, the term "or" is used to refer to a nonexclusive or, such that "A or B" includes "A but not B," "B but not A," and "A and B," unless otherwise indicated. In this document, the terms "including" and "in which" are used as the plain-English equivalents of the respective terms "comprising" and "wherein." Also, in the following claims, the terms "including" and "comprising" are open-ended, that is, a system, user equipment (UE), article, composition, formulation, or process that includes elements in addition to those listed after such a term in a claim are still deemed to fall within the scope of that claim. Moreover, in the following claims, the terms "first," "second," and "third," etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing, by one or more computing devices, heterogeneous data from a plurality of data sources;
extracting, by the one or more computing devices, structured entities from the heterogeneous data;
transforming, using a data normalization engine executed by the one or more computing devices, the extracted structured entities into an electronic record comprising a plurality of machine-interpretable subsystem-specific data sections stored in a memory, each subsystem-specific data section comprising a temporally-weighted dependency graph having nodes representing subsystem state vectors and directed edges annotated with temporal-weight coefficients;
receiving, by the one or more computing devices, an intervention specification identifying a proposed change and at least one parameter associated with the proposed change;
generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially:
traversing the plurality of subsystem-specific data sections according to the temporally-weighted dependency graph using a weight-normalized topological traversal that determines an execution order for the distributed processing node,
determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph,
propagating the predicted modifications across the directed edges of the temporally-weighted dependency graph using edge-specific propagation functions stored in the memory to identify secondary effects on related subsystems, and
aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and
transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.

2. The method of claim 1, wherein the heterogeneous data comprise at least one of laboratory test data, diagnostic imaging data, genomic or proteomic datasets, clinician notes, procedure records, medication histories, or wearable-device sensor data associated with a patient.

3. The method of claim 1, wherein transforming the extracted structured entities into the electronic record comprises:
generating a patient-specific computational physiology file including a plurality of subsystem-specific data sections corresponding to physiological systems comprising at least one of hematologic, endocrine, immune, metabolic, hepatic, renal, cardiovascular, neurological, or gastrointestinal systems, and wherein the dependency graph indicates causal biological relationships among the physiological systems.

4. The method of claim 1, wherein the intervention specification identifies a therapeutic agent and at least one dosage parameter, and wherein the output comprises an intervention impact report presenting, for each dosage parameter, predicted dose-dependent biomarker trajectories, organ-level responses, contraindications, and safety thresholds derived from the consolidated intervention analysis data structure.

5. The method of claim 1, wherein transforming the extracted structured entities into the electronic record comprises:
performing ontology mapping to a standardized terminology system;
performing unit conversions;
resolving duplicate entities; and
ordering data chronologically to generate a temporally aligned and harmonized dataset.

6. The method of claim 1, wherein generating the parameter-dependent predictions comprises:
executing subsystem evaluations in parallel across distributed computing resources, including graphics processing units configured to accelerate radiomics feature extraction and natural language processing workloads.

7. The method of claim 1, further comprising:
dynamically updating the electronic record and regenerating the consolidated intervention analysis data structure in response to receipt of new or revised data from one or more data sources, wherein the artificial intelligence model employs reinforcement learning to refine predictive accuracy based on prior simulation outcomes.

8. The method of claim 1, wherein the electronic record further comprises machine-generated text describing at least one of subsystem interactions, temporal biomarker trajectories, or predicted physiological outcomes.

9. The method of claim 1, wherein the dependency graph comprises a directed acyclic graph modeling causal relationships among subsystems.

10. The method of claim 1, wherein generating the parameter-dependent predictions comprises:
computing dose-response curves representing linear, sigmoidal, or multiphasic relationships between intervention parameters and subsystem responses.

11. The method of claim 1, wherein the output further comprises a safety envelope identifying parameter ranges associated with predicted adverse subsystem responses.

12. The method of claim 1, wherein generating predicted modifications further comprises adjusting subsystem responses based on patient-specific genomic or pharmacogenomic variants.

13. The method of claim 1, further comprising:
receiving user-initiated edits to the electronic record through the graphical user interface prior to generating the parameter-dependent predictions.

14. The method of claim 1, wherein the one or more computing devices operate within a distributed computing environment comprising a plurality of processing nodes, each processing node including at least one processor and a local memory, the method further comprising:
partitioning the plurality of subsystem-specific data sections across the processing nodes based on data dependencies indicated by the dependency graph;
executing, in parallel across the processing nodes, respective simulations corresponding to the subsystem-specific data sections;
performing inter-node communication to propagate predicted modifications between processing nodes representing interdependent subsystems;
synchronizing the propagated predicted modifications to generate the consolidated intervention analysis data structure; and
dynamically allocating computational resources based on workload metrics to reduce latency and increase throughput during generation of the parameter-dependent predictions.

15. The method of claim 1, wherein the heterogeneous data represent a municipal or regional infrastructure network comprising the subsystems including at least one of transportation, energy distribution, waste management, water supply, or public safety services, and wherein the intervention specification identifies a proposed policy or operational change, the predicted responses indicating projected impacts on at least one of traffic flow, resource utilization, environmental metrics, or public-service performance.

16. The method of claim 1, wherein the heterogenous data represent an industrial process comprising at least one of manufacturing, energy distribution, or logistics subsystems, and wherein the intervention specification identifies operational or regulatory adjustments to the industrial process.

17. The method of claim 1, wherein extracting the structured entities comprises using at least one of optical character recognition, natural language processing, statistical analysis, or feature extraction techniques.

18. A non-transitory computer-readable medium storing instructions operable to cause one or more computing devices to perform operations comprising:
accessing, by the one or more computing devices, heterogeneous data from a plurality of data sources;
extracting, by the one or more computing devices, structured entities from the heterogeneous data;
transforming, using a data normalization engine executed by the one or more computing devices, the extracted structured entities into an electronic record comprising a plurality of machine-interpretable subsystem-specific data sections stored in a memory, each subsystem-specific data section comprising a temporally-weighted dependency graph having nodes representing subsystem state vectors and directed edges annotated with temporal-weight coefficients;
receiving, by the one or more computing devices, an intervention specification identifying a proposed change and at least one parameter associated with the proposed change;
generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially:
traversing the plurality of subsystem-specific data sections according to the temporally-weighted dependency graph using a weight-normalized topological traversal that determines an execution order for the distributed processing node,
determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph,
propagating the predicted modifications across the directed edges of the temporally-weighted dependency graph using edge-specific propagation functions stored in the memory to identify secondary effects on related subsystems, and
aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and
transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.

19. The non-transitory computer-readable medium of claim 18, wherein the heterogeneous data comprise at least one of laboratory test data, diagnostic imaging data, genomic or proteomic datasets, clinician notes, procedure records, medication histories, or wearable-device sensor data associated with a patient.

20. A system comprising:
one or more processors; and
a memory storing instructions operable to cause the one or more processors to perform operations comprising:
accessing, by one or more computing devices, heterogeneous data from a plurality of data sources;
extracting, by the one or more computing devices, structured entities from the heterogeneous data;
transforming, using a data normalization engine executed by the one or more computing devices, the extracted structured entities into an electronic record comprising a plurality of machine-interpretable subsystem-specific data sections stored in the memory, each subsystem-specific data section comprising a temporally-weighted dependency graph having nodes representing subsystem state vectors and directed edges annotated with temporal-weight coefficients;
receiving, by the one or more computing devices, an intervention specification identifying a proposed change and at least one parameter associated with the proposed change;
generating, using an artificial intelligence model and a distributed graph-scheduled reasoning pipeline executed across a plurality of processing nodes configured to simulate subsystem interactions by executing subsystem-specific computations on processing nodes assigned according to a topological ordering of the temporally-weighted dependency graph, parameter-dependent predictions by sequentially:
traversing the plurality of subsystem-specific data sections according to the temporally-weighted dependency graph using a weight-normalized topological traversal that determines an execution order for the distributed processing node,
determining, for each subsystem-specific data section, predicted modifications associated with the proposed change while maintaining temporal causality constraints by computing updated subsystem state vectors and storing each update as a time-indexed delta entry within a delta profile tensor associated with a corresponding node of the temporally-weighted dependency graph,
propagating the predicted modifications across the directed edges of the temporally-weighted dependency graph using edge-specific propagation functions stored in the memory to identify secondary effects on related subsystems, and
aggregating the predicted modifications and the secondary effects into a consolidated intervention analysis data structure comprising, for each subsystem, a delta profile tensor including predicted time-indexed state-vector updates, confidence-metric values computed from propagation coefficients, and causal-provenance identifiers referencing the corresponding graph nodes and edges; and
transmitting, by the one or more computing devices, a signal for display of an output indicating predicted responses to the proposed change, the output comprising a representation of the consolidated intervention analysis data structure via a graphical user interface that enables a user to visualize predicted subsystem responses, explore alternative intervention scenarios, and compare predicted outcomes generated using the delta profile tensors and causal-provenance identifiers stored within the temporally-weighted dependency graph.
